(19) United States
(12) Patent Application Publication
(10) Pub. No.: US 2022/0335269 A1
(43) Pub. Date: Oct. 20, 2022

(54) Compression Framework for Distributed or Federated Learning with Predictive Compression Paradigm

(71) Applicant: Nokia Technologies Oy, Espoo (FI)

(72) Inventors: Honglei Zhang, Tampere (FI); Hamed Rezazadegan Tavakoli, Espoo (FI); Francesco Cricri, Tampere (FI); Homayun Afrabandpey, Espoo (FI); Goutham Rangu, Tampere (FI); Emre Baris Aksu, Tampere (FI)

(21) Appl. No.: 17/717,729

(22) Filed: Apr. 11, 2022

Related U.S. Application Data
(60) Provisional application No. 63/173,583, filed on Apr. 12, 2021.

(51) Int. Cl. G06N 3/02

(52) U.S. Cl. CPC G06N 3/02

(57) ABSTRACT

An apparatus includes circuitry configured to: receive a plurality of compressed residual local weight updates from a plurality of respective institutes with a plurality of a respective first parameter, the first parameter used to determine a plurality of respective predicted local weight updates; determine a plurality of local weight updates or a plurality of adjusted local weight updates based on the plurality of compressed residual local weight updates and the plurality of respective predicted local weight updates; aggregate the plurality of determined local weight updates or the plurality of adjusted local weight updates to generate an intended global weight update, and update a model on a server based at least on the intended global weight update, the model used to perform a task; and transfer a compressed residual global weight update to the institutes with a second parameter, the second parameter used to determine a predicted global weight update.

### RELATED APPLICATION

This application claims priority to U.S. Provisional Application No. 63/173,583, filed Apr. 12, 2021, which is hereby incorporated by reference in its entirety.

### STATEMENT OF GOVERNMENT SUPPORT

The project leading to this application has received funding from the ECSEL Joint Undertaking (JU) under grant agreement No 783162. The JU receives support from the European Union's Horizon 2020 research and innovation programme and Netherlands, Czech Republic, Finland, Spain, Italy.

### TECHNICAL FIELD

The examples and non-limiting embodiments relate generally to multimedia transport and machine learning and, more particularly, to a compression framework for distributed or federated learning with predictive compression paradigm.

### BACKGROUND

It is known to perform data compression and decoding in a multimedia system.

### SUMMARY

In accordance with an aspect, an apparatus includes at least one processor; and at least one non-transitory memory including computer program code; wherein the at least one memory and the computer program code are configured to, with the at least one processor, cause the apparatus at least to: receive a plurality of compressed residual local weight updates from a plurality of respective institutes with a plurality of a respective at least one first parameter, the at least one first parameter used to determine a plurality of respective predicted local weight updates; determine a plurality of local weight updates or a plurality of adjusted local weight updates based on the plurality of compressed residual local weight updates and the plurality of respective predicted local weight updates; aggregate the plurality of determined local weight updates or the plurality of adjusted local weight updates to generate an intended global weight update, and update a model on a server based at least on the intended global weight update, the model used to perform at least one task; and transfer at least one compressed residual global weight update to the plurality of institutes with at least one second parameter, the at least one second parameter used to determine at least one predicted global weight update.

In accordance with an aspect, an apparatus includes at least one processor; and at least one non-transitory memory including computer program code; wherein the at least one memory and the computer program code are configured to, with the at least one processor, cause the apparatus at least to: generate a compressed residual local weight update after compressing a difference between an intended local weight update and a predicted local weight update; transfer the compressed residual local weight update from an institute to a server or other institute with at least one first parameter, the at least one first parameter used to determine the predicted local weight update; receive a compressed residual global weight update from the server or the other institute with at least one second parameter, the at least one second parameter used to determine a predicted global weight update; and update a local model on the institute based in part on the compressed residual global weight update, the local model used to perform at least one task.

In accordance with an aspect, an apparatus includes at least one processor; and at least one non-transitory memory including computer program code; wherein the at least one memory and the computer program code are configured to, with the at least one processor, cause the apparatus at least to: receive at least one compressed residual local weight update from at least one institute with at least one first parameter, the at least one first parameter used to determine at least one predicted local weight update; determine at least one local weight update or at least one adjusted local weight update based on the at least one compressed residual local weight update and the at least one predicted local weight update; aggregate the determined at least one local weight update or the at least one adjusted local weight update to generate an intended global weight update, and update a model on a server based at least on the intended global weight update, the model used to perform at least one task; and transfer at least one compressed residual global weight update to the at least one institute with at least one second parameter, the at least one second parameter used to determine at least one predicted global weight update.

### BRIEF DESCRIPTION OF THE DRAWINGS

The foregoing aspects and other features are explained in the following description, taken in connection with the accompanying drawings, wherein:

FIG. 1 shows schematically an electronic device employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 shows schematically a block chart of an encoder used for data compression on a general level.

FIG. 5 shows a distributed or federated learning system architecture and the communication of weight updates between the central server and institutes.

FIG. 6 shows weight updates at iteration t, where subscript i and j indicate the institute identification.

FIG. 7 shows model states and weight updates of a distributed or federated learning system based on the asynchronized framework at iteration t.

FIG. 8 shows another distributed or federated learning system architecture and the communication of weight residuals between the central server and institutes.

FIG. 9 is an example apparatus configured to implement a compression framework for distributed or federated learning with predictive compression paradigm, based on the examples described herein.

FIG. 10 is an example method to implement a compression framework for distributed or federated learning with predictive compression paradigm, based on the examples described herein.

FIG. 11 is another example method to implement a compression framework for distributed or federated learning with predictive compression paradigm, based on the examples described herein.

FIG. 12 is another example method to implement a compression framework for distributed or federated learning with predictive compression paradigm, based on the examples described herein.

### DETAILED DESCRIPTION OF EXAMPLE EMBODIMENTS

Described herein is a compression framework for distributed or federated learning with predictive compression paradigm. The examples herein are about encoding weight-updates of a neural network. The neural networks for which weight-updates are compressed may perform any task, such as data compression, data decompression, video compression, video decompression, image or video classification, object classification, object detection, object tracking, speech recognition, language translation, music transcription, etc.

Two types of compressed data are distinguished herein. One type is the compressed weight-updates, and the described methods are mainly about new methods for achieving this. Another type is the data which is compressed by the neural networks, in the specific use case where those neural networks are used for compressing data such as video data, but this is only one example task for those neural networks.

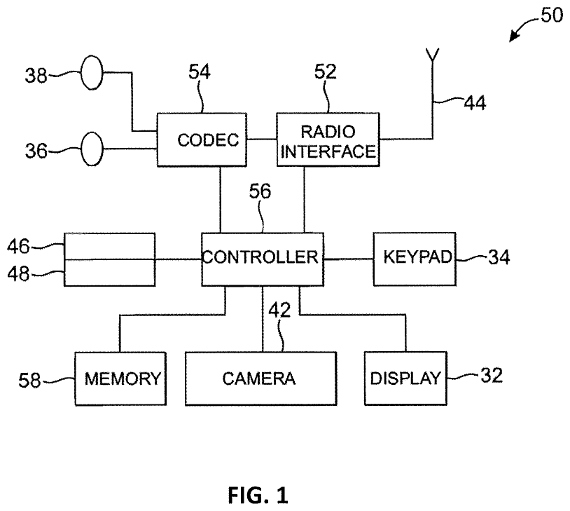

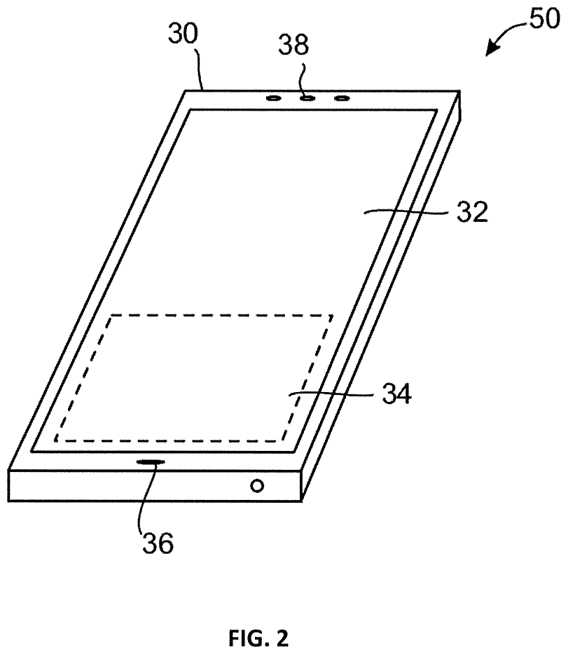

The following describes in detail a suitable apparatus and possible mechanisms for a neural network weight update encoding process according to embodiments. In this regard reference is first made to FIG. 1 and FIG. 2, where FIG. 1 shows an example block diagram of an apparatus 50. The apparatus may be an Internet of Things (IoT) apparatus configured to perform various functions, such as for example, gathering information by one or more sensors, receiving or transmitting information, analyzing information gathered or received by the apparatus, or the like. The apparatus may comprise a neural network weight update coding system, which may incorporate a codec. FIG. 2 shows a layout of an apparatus according to an example embodiment. The elements of FIG. 1 and FIG. 2 are explained next.

The electronic device 50 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 50 may comprise a housing 30 for incorporating and protecting the device. The apparatus 50 further may comprise a display 32 in the form of a liquid crystal display. In other embodiments of the examples described herein the display may be any suitable display technology suitable to display an image or video. The apparatus 50 may further comprise a keypad 34. In other embodiments of the examples described herein any suitable data or user interface mechanism may be employed. For example the user interface may be implemented as a virtual keyboard or data entry system as part of a touch-sensitive display.

The apparatus may comprise a microphone 36 or any suitable audio input which may be a digital or analog signal input. The apparatus 50 may further comprise an audio output device which in embodiments of the examples described herein may be any one of: an earpiece 38, speaker, or an analog audio or digital audio output connection. The apparatus 50 may also comprise a battery (or in other embodiments of the examples described herein the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments of the examples described herein may store both data in the form of image and audio data and/or may also store instructions for implementation on the controller 56. The controller 56 may further be connected to codec circuitry 54 suitable for carrying out coding/compression of neural network weight updates and/or decoding of audio and/or video data or assisting in coding and/or decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and/or for receiving radio frequency signals from other apparatus(es).

The apparatus 50 may comprise a camera capable of recording or detecting individual frames which are then passed to the codec 54 or the controller for processing. The apparatus may receive the video image data or machine learning data for processing from another device prior to transmission and/or storage. The apparatus 50 may also receive either wirelessly or by a wired connection the image for coding/decoding. The structural elements of apparatus 50 described above represent examples of means for performing a corresponding function.

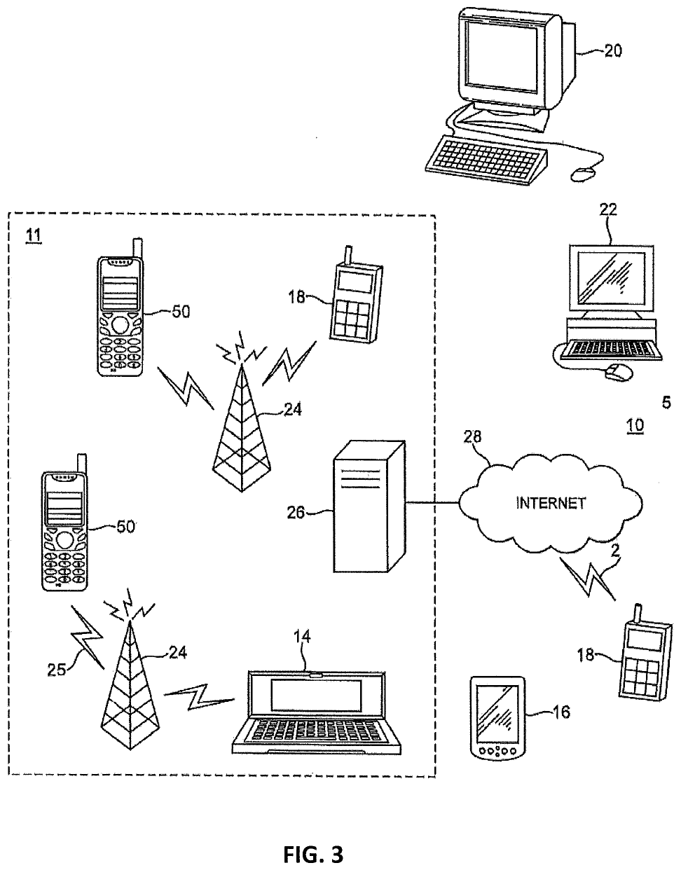

With respect to FIG. 3, an example of a system within which embodiments of the examples described herein can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA, LTE, 4G, 5G network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments of the examples described herein.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport, or a head mounted display (HMD).

The embodiments may also be implemented in a set-top box; i.e. a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 25 to a base station 24. The base station may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

One important application where reducing the bitrate of weight-updates is important, is the use case of neural network based codecs, such as neural network based video codecs. Video codecs may use one or more neural networks. In a first case, the video codec may be a conventional video codec such as the Versatile Video Codec (VVC/H.266) that has been modified to include one or more neural networks. Examples of these neural networks are:

1. a neural network filter to be used as one of the in-loop filters of VVC
2. a neural network filter to replace one or more of the in-loop filter(s) of VVC
3. a neural network filter to be used as a post-processing filter
4. a neural network to be used for performing intra-frame prediction
5. a neural network to be used for performing inter-frame prediction.

In a second case, which is usually referred to as an end-to-end learned video codec, the video codec may comprise a neural network that transforms the input data into a more compressible representation. The new representation may be quantized, lossless compressed, then lossless decompressed, dequantized, and then another neural network may transform its input into reconstructed or decoded data.

In both of the above two cases, there may be one or more neural networks at the decoder-side, and consider the example of one neural network filter. The encoder may fine tune the neural network filter by using the ground-truth data which is available at encoder side (the uncompressed data). Finetuning may be performed in order to improve the neural network filter when applied to the current input data, such as to one or more video frames. Finetuning may comprise running one or more optimization iterations on some or all the learnable weights of the neural network filter. An optimization iteration may comprise computing gradients of a loss function with respect to some or all the learnable weights of the neural network filter, for example by using the backpropagation algorithm, and then updating the some or all learnable weights by using an optimizer, such as the Stochastic Gradient Descent optimizer. The loss function may comprise one or more loss terms. One example loss term may be the mean squared error (MSE). Other distortion metrics may be used as the loss terms. The loss function may be computed by providing one or more data to the input of the neural network filter, obtaining one or more corresponding outputs from the neural network filter, and computing a loss term by using the one or more outputs from the neural network filter and one or more ground-truth data. The difference between the weights of the finetuned neural network and the weights of the neural network before finetuning is referred to as the weight-update. This weight-update needs to be encoded, provided to the decoder side together with the encoded video data, and used at the decoder side for updating the neural network filter. The updated neural network filter is then used as part of the video decoding process or as part of the video post-processing process. It is desirable to encode the weight-update such that it requires a small number of bits. Thus, the examples described herein consider also this use case of neural network based codecs as a potential application of the compression of weight-updates.

In further description of the neural network based codec use case, an MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

A video codec consists of an encoder that transforms the input video into a compressed representation suited for storage/transmission and a decoder that can uncompress the compressed video representation back into a viewable form. A video encoder and/or a video decoder may also be separate from each other, i.e. need not form a codec. Typically the encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction and current picture referencing), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process as temporal prediction. Inter prediction or temporal prediction may sometimes be referred to as motion compensation or motion-compensated prediction.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in the spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

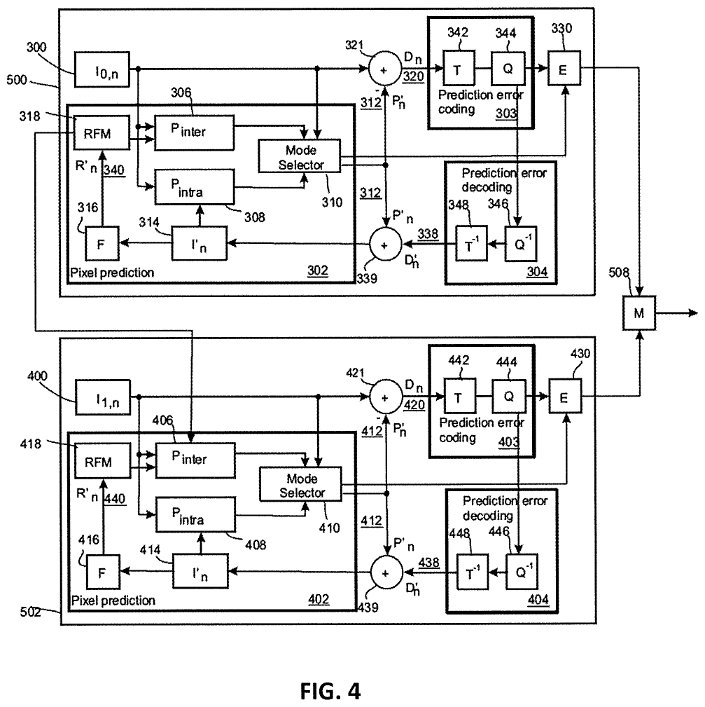

FIG. 4 shows a block diagram of a general structure of a video encoder. FIG. 4 presents an encoder for two layers, but it would be appreciated that presented encoder could be similarly extended to encode more than two layers. FIG. 4 illustrates a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406 (Pᵢₙₜₑᵣ) an intra-predictor 308, 408 (Pᵢₙₜᵣₐ), a mode selector 310, 410, a filter 316, 416 (F), and a reference frame memory 318, 418 (RFM). The pixel predictor 302 of the first encoder section 500 receives 300 base layer images (I_{0,n}) of a video stream to be encoded at both the inter-predictor 306 (which determines the difference between the image and a motion compensated reference frame 318) and the intra-predictor 308 (which determines a prediction for an image block based only on the already processed parts of the current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300.

Correspondingly, the pixel predictor 402 of the second encoder section 502 receives 400 enhancement layer images (I_{1,n}) of a video stream to be encoded at both the inter-predictor 406 (which determines the difference between the image and a motion compensated reference frame 418) and the intra-predictor 408 (which determines a prediction for an image block based only on the already processed parts of the current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 (Dₙ) which is input to the prediction error encoder 303, 403.

The pixel predictor 302, 402 further receives from a preliminary reconstructor 339, 439 the combination of the prediction representation of the image block 312, 412 (P′ₙ) and the output 338, 438 (D′ₙ) of the prediction error decoder 304, 404. The preliminary reconstructed image 314, 414 (I′ₙ) may be passed to the intra-predictor 308, 408 and to the filter 316, 416. The filter 316, 416 receiving the preliminary representation may filter the preliminary representation and output a final reconstructed image 340, 440 (R′ₙ) which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be the source for inter-layer sample prediction and/or inter-layer motion information prediction of the enhancement layer according to some embodiments, the reference frame memory 318 may also be connected to the inter-predictor 406 to be used as the reference image against which a future enhancement layer picture 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be the source for predicting the filtering parameters of the enhancement layer according to some embodiments.

The prediction error encoder 303, 403 comprises a transform unit 342, 442 (T) and a quantizer 344, 444 (Q). The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder 304, 404 may be considered to comprise a dequantizer 346, 446 (Q⁻¹), which dequantizes the quantized coefficient values, e.g. DCT coefficients, to reconstruct the transform signal and an inverse transformation unit 348, 448 (T⁻¹), which performs the inverse transformation to the reconstructed transform signal wherein the output of the inverse transformation unit 348, 448 contains reconstructed block(s). The prediction error decoder may also comprise a block filter which may filter the reconstructed block(s) according to further decoded information and filter parameters.

The entropy encoder 330, 430 (E) receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508 (M).

Fundamentals of Neural Networks.

A neural network (NN) is a computation graph consisting of several layers of computation. Each layer consists of one or more units, where each unit performs an elementary computation. A unit is connected to one or more other units, and the connection may be associated with a weight. The weight may be used for scaling the signal passing through the associated connection. Weights are learnable parameters, i.e., values which can be learned from training data. There may be other learnable parameters, such as those of batch-normalization layers.

Two of the most widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of the preceding layers, and provide output to one or more of the following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of devices, such as mobile phones. Examples include image and video analysis and processing, social media data analysis, device usage data analysis, etc.

The most important property of neural nets (and other machine learning tools) is that they are able to learn properties from input data, either in a supervised way or in an unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

Training a neural network is an optimization process, but the final goal is different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data is usually split into at least two sets, the training set and the validation set. The training set is used for training the network, i.e., to modify its learnable parameters in order to minimize the loss. The validation set is used for checking the performance of the network on data which was not used to minimize the loss, as an indication of the final performance of the model. In particular, the errors on the training set and on the validation set are monitored during the training process to understand the following things: i) if the network is learning at all—in this case, the training set error should decrease, otherwise the model is in the regime of underfitting, and ii) if the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set, but performs poorly on a set not used for tuning its parameters.

Normally, a gradient descent or a variation of this method is used to train a neural network. The training is performed in an iteration procedure. At each iteration step, an update is derived for the parameters, for example, weights of the convolution kernels or fully connected layers, of the neural network and the model is updated. The iteration continues until the system reaches a predefined criterion, for example, the validation loss converges or the maximum number of iterations has been reached.

Distributed and Federated Learning

Distributed learning is a machine learning technique where the training is distributed to multiple institutes. Local models are trained with local data by each institute and the parameters of the local models are exchanged between these institutes, either in a centralized or decentralized manner, to generate a global model shared by all institutes. In a centralized distributed learning system, each institute exchanges the model parameters with a central server. Whereas when no central server is used in a decentralized distributed system, parameters are exchanged directly between the institutes. Different from a distributed learning system, where the training data are shared or allowed to be shared among all the institutes, the institute in a federated learning system uses its local data for the training, such that neither the central server nor other institutes can access this local data. Federated learning is an important learning technique for applications where data privacy and data security are of major concern.

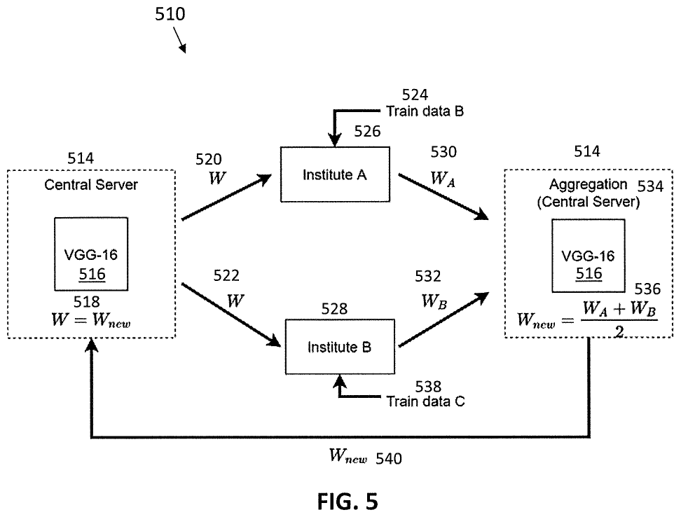

FIG. 5 describes a general centralized federated learning framework, showing a system 510 where two institutions (institution A 526 and institution B 528) work together with a central server 514. The FedAvg algorithm is used in this system.

In a distributed or federated learning system, the training is performed iteratively. An initial model M (such as a model comprising weight 520 and a model comprising weight 522) is first distributed to the institutes 526 and 528. At each iteration, an institute A 526 and an institute B 528 perform a training step using the local data (train data B 524 and train data C 538) and generate institute A weight update W_{A} 530 and institute B weight update W_{B} 532, respectively. A weight-update may be generated for example by training for a certain number of iterations, then the difference between the weights after the training iterations and the weights before the training iterations is computed, and this difference represents the weight-update. The term local weight update is used to refer to the weight update generated by an institute. The local weight updates from all involved institutes are then transferred to the central server 514 and aggregated 534 to generate a global weight update 536. In an example, the global weight update 536, such as the one shown in FIG. 5, is W_{new}=(W_{A}+W_{B})/2. Next, the model 516 on the central server 514 is updated 540/518 using this global weight update 540/518, as M_{new}=M+W_{new} and the global weight update 540/518 is transferred to the institutes 526 and 528 to update the local model on the institutes' side. In the example shown in FIG. 5, the model 516 on the central server 514 is VGG-16.

A weight update can be lossily compressed, for example, sparsified and quantized, before sending to a receiver. The terms intended and actual are used to indicate the data before and after the lossy compression respectively.

Table 1 shows a normal working procedure between the central server and an institute. The same procedure applies to multi-institute cases. As described herein, M is used to represent the model weights, and W is used to represent a weight update, i.e.

M^{(t)}=M^{(t-1)}+W^{(t)}.

Notations used in the following table are:

t: iteration index
i: is institute index
K: the total number of institutes
M^{(t)}: model at iteration t
M⁽⁰⁾: initial model
W^{(t)}: intended global weight update calculated on the central server
Wᵢ^{(t)}: intended local weight update calculated on institute i
\tilde{W}^{(t)}: actual global weight update sent from the central server to institute i
\tilde{W}ᵢ^{(t)}: actual local weight update sent from institute i to the central server
q(⋅): compression function, for example, sparsification and quantization
f(⋅): weight updates aggregation function, for example, FedAvg

TABLE 1

| | Central Server | Communication | Institute i |
|---|---|---|---|
| Initialization | Initialize M⁽⁰⁾ | | |

. . .

| | | | |
|---|---|---|---|
| Iteration t | | | Train M^{(t-1)} to |
| | | | get Wᵢ^{(t)} |
| | | | Compress |
| | | | \tilde{W}ᵢ^{(t)} = q(Wᵢ^{(t)}) |
| | | ← \tilde{W}ᵢ^{(t)} | Send \tilde{W}ᵢ^{(t)} to |
| | | | server |
| | Aggregate all updates | | |
| | W^{(t)} = | | |
| | f(\tilde{W}₁^{(t)}, . . . , \tilde{W}_{K}^{(t)}) | | |
| | Compress | | |
| | \tilde{W}^{(t)} = q(W^{(t)}) | | |
| | M^{(t)} = M^{(t-1)} + \tilde{W}^{(t)} | | |
| | Send update \tilde{W}^{(t)} | → \tilde{W}^{(t)} | |
| | | | M^{(t)} = |
| | | | M^{(t-1)} + \tilde{W}^{(t)} |
| Iteration t + 1 | | | Train M^{(t)} to get |
| | | | Wᵢ^{(t+1)} |

. . .

Table 1 shows the operations and communication between the central server and institute i of a distributed or federated learning system. The operations specified in Table 1 continue until the central server stops the training. In the FedAvg case, the aggregation is simply an average operation.

Training a deep neural network normally requires many iterations. For a distributed or federated learning system, weight updates are communicated between the central server and the institutes at each iteration. This requires a massive amount of data to be transmitted between the central server and the institutes. Efficient training techniques and compression methods are required to reduce the amount of data to be transferred.

Described herein is a compression technique that minimizes the amount of data transferred between a central server and institutes, i.e.

$${\sum }_{t = 1}^{T} ( {\sum }_{i = 1}^{K} ( {W}_{- i}^{( t )} + {W}_{i}^{( t )} ) )$$

where T is the number of iterations, K is the number of institutes, W₋ᵢ^{(t)} is the actual global weight updates sent from the central server to institute i, and Wᵢ^{(t)} is the actual local weight update sent from institute i to the central server.

In the methods described herein, instead of sending weight updates directly, the residual of the weight updates are sent in both directions. The residual of the weight updates is the difference between the actual weight updates and the predicted weight updates that are calculated on the receiver side. The sender determines the method that the predicted weight updates are calculated and sends the corresponding parameters. The proposed mechanism can be combined with other quantization and sparsification techniques to further reduce the amount of data being transferred. Also described herein are two frameworks of the residual-based weight updates communication mechanism. In one framework, the models on the central server and the institutes are identical after each iteration. In another framework, the models on the central server and the institutes can be different after each iteration due to the loss introduced during the quantization and compression operation. The second framework can achieve a higher compression rate compared with the first one with the cost of asynchronized models on the central server and the institutes.

Described herein are also various methods to calculate the predicted weight updates and the parameters to be communicated between a sender and the receivers.

The methods described herein apply to both a centralized and decentralized setup of a distributed or federated learning system. In a centralized setup, the methods apply to the institutes and the central server to reduce the communication cost. In a decentralized setup, the methods apply to the institutes that are involved in communication.

In a traditional distributed or federated learning system, weight updates or compressed values of the weight updates, for example, sparsified or quantized, are sent between the central server and the institutes. In the examples described herein, the residual of the weight updates and the parameters to calculate the predicted weight update are sent during the communication. In other words, instead of sending W₋ᵢ^{(t)} and Wᵢ^{(t)} directly, sent is the residual \tilde{W}₋ᵢ^{(t)} and \tilde{W}₋ᵢ^{(t)}, and parameters θ₋ᵢ^{(t)}, and ϕᵢ^{(t)}, where \tilde{W}₋ᵢ^{(t)}=W₋ᵢ^{(t)}−W̅₋ᵢ^{(t)}, \tilde{W}ᵢ^{(t)}=Wᵢ^{(t)}−W̅ᵢ^{(t)}, W̅₋ᵢ^{(t)} and W̅ᵢ^{(t)} are the predicted global and local weight updates calculated with the help of parameters θ₋ᵢ^{(t)}, and ϕᵢ^{(t)}.

Two frameworks of the distributed or federated learning system are next described that are based on the proposed residual mechanism.

Framework 1: Synchronized Central Server and Institutes

In this framework, the model on the central server and the institutes are identical after each iteration. The central server sends the same residual of a global weight update to all institutes. In this section, the subscript −i is omitted when describing the global data that are calculated at the central server and sent to institute i.

The prediction functions for the weight update are defined as:

W̅^{(t)}=g(W^{(t-1)}, . . . ,W⁽¹⁾;θ^{(t)}) Equation (1)

W̅ᵢ^{(t)}=h(Wᵢ^{(t-1)}, . . . ,Wᵢ⁽¹⁾,W^{(t-1)}, . . . ,W⁽¹⁾;ϕᵢ^{(t)}) Equation (2)

where W^{(t)} is the actual global weight update on the central server at iteration t, Wᵢ^{(t)} is the actual local weight update on institute i at iteration t, W^{(t-1)} . . . W⁽¹⁾ and Wᵢ^{(t-1)} . . . Wᵢ⁽¹⁾ are previous weight updates, and θ^{(t)} and ϕ^{(t)} are parameters sent together with the weight update residual.

Table 2 illustrates the detailed procedure of this method. Notations used in this table are:

M⁽⁰⁾: initial weights of the model
M^{(t)}: model after iteration t
Fᵢ^{(t)}: intended weight update at institute i after the training with model M^{(t-1)}
W̅ᵢ^{(t)}: predicted local weight update of institute i
\tilde{W}ᵢ^{(t)}: actual weight update residual sent from institute i to the central server
W̅^{(t)}: predicted global weight update
\tilde{W}^{(t)}: actual global weight update residual sent from the central server to the institutes
G^{(t)}: intended global weight update at the central server after the updates from all institutes are aggregated
W^{(t)}: the actual global weight updates performed at the central server at iteration t
ϕᵢ^{(t)}: parameters to calculate W̅ᵢ^{(t)}
θ^{(t)}: parameters to calculate W̅^{(t)}
q(⋅): a compression operation, for example, sparsification, quantization
g(⋅),h(⋅): prediction function defined by Equations (1) and (2).

TABLE 2

| | Central Server | Communication | Institute i |
|---|---|---|---|
| Initialization | Initialize M⁽⁰⁾ | | |
| | | → M⁽⁰⁾ | |
| Iteration i | | | Train M^{(t-1)} to get |
| | | | weight update Fᵢ^{(t)} |
| | | | Calculate W̅ᵢ^{(t)}, |
| | | | ϕᵢ^{(t)} |
| | | | \tilde{W}ᵢ^{(t)} = |
| | | | q(Fᵢ^{(t)} − W̅ᵢ^{(t)}) |
| | | ← \tilde{W}ᵢ^{(t)}, ϕᵢ^{(t)} | |
| | W̅ᵢ^{(t)} = h(•, ϕᵢ^{(t)}) | | |
| | Wᵢ^{(t)} = W̅ᵢ^{(t)} + \tilde{W}ᵢ^{(t)} | | |
| | Aggregate updates | | |
| | G^{(t)} = | | |
| | f(W₁^{(t)}, . . . , W_{K}^{(t)}) | | |
| | Calculate W̅^{(t)}, θ^{(t)} | | |
| | \tilde{W}^{(t)} = | | |
| | q(G^{(t)} − W̅^{(t)}) | | |
| | W^{(t)} = W̅^{(t)} + \tilde{W}^{(t)} | | |
| | M^{(t)} = M^{(t-1)} + W^{(t)} | | |
| | | → \tilde{W}^{(t)}, θ^{(t)} | |
| | | | W̅^{(t)} = g(•; θ^{(t)}) |
| | | | W^{(t)} = |
| | | | W̅^{(t)} + \tilde{W}^{(t)} |
| | | | M^{(t)} = |
| | | | M^{(t-1)} + W^{(t)} |
| Iteration i + 1 | | | Train M^{(t)} to get |
| | | | weight update |
| | | | Hᵢ^{(t+1)} |

Table 2 shows the operation and communication of a distributed or federated learning system that is based on the described synchronized weight updates residual communication under framework 1.

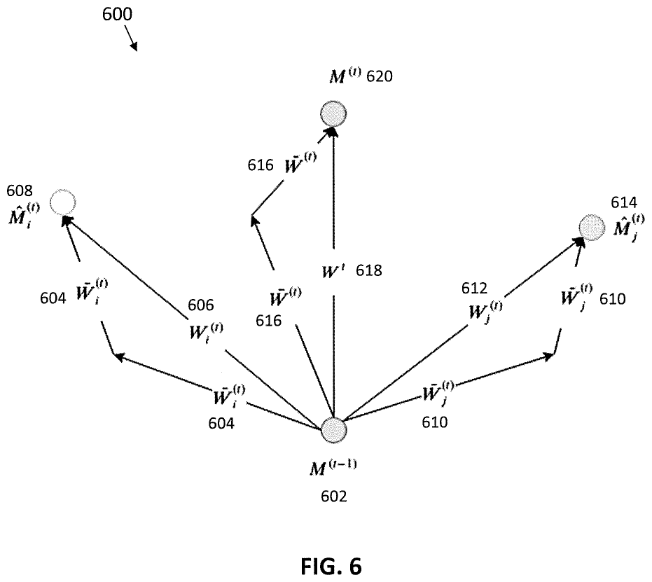

FIG. 6 shows the relationship 600 of the weight updates, predicted weight updates and weight update residuals at iteration t. Note that all institutes receive the same global weight update residual from the central server and the model on the central server and each institute remains identical after the iteration.

FIG. 6 shows the model after iteration t−1 (M^{(t-1)} 602), as well as the model after iteration t (M^{(t)} 620). FIG. 6 further shows the predicted local weight update W̅^{(t)} 604 of institute i at iteration t, the actual local weight update Wᵢ^{(t)} 606 of institute i at iteration t, and the local model update \hat{M}ᵢ^{(t)} 608 of institute i at iteration t. FIG. 6 further shows the predicted local weight update W̅ⱼ^{(t)} 610 of institute j at iteration t, the actual local weight update Wⱼ^{(t)} 612 of institute j at iteration t, and the local model update \hat{M}ⱼ^{(t)} 614 of institute j at iteration t. FIG. 6 further shows the predicted global weight update W̅^{(t)} 616 at iteration t, and the actual global weight update W^{t} 618 at iteration t.

In one example, such as that shown in FIG. 6, the actual local weight update Wᵢ^{(t)} 606 of institute i at iteration t is given by the predicted local weight update 604 of institute i at iteration t plus the weight update residual sent from institute i to the central server, or respectively Wᵢ^{(t)}=W̅ᵢ^{(t)}+\tilde{W}ᵢ^{(t)}. In one example, such as that shown in FIG. 6, the actual local weight update Wⱼ^{(t)} 612 of institute j at iteration t is given by the predicted local weight update 610 of institute j at iteration t plus the weight update residual sent from institute j to the central server, or respectively Wⱼ^{(t)}=W̅ⱼ^{(t)}+\tilde{W}ⱼ^{(t)}. In one example, such as that shown in FIG. 6, the actual global weight update W^{t} 618 at iteration t is given by the predicted global weight update 616 plus a weight update residual sent from the central server to the institutes, or respectively W^{t}=W̅^{(t)}+\tilde{W}^{(t)}.

Framework 2: Asynchronized Central Server and Institutes

In this framework, the model at the central server and institutes can be different. The difference is due to the lossy compression used to transfer data between the central server and the institutes. This framework can achieve a higher compression rate for the communication from the central server to the institutes. In this section, subscript −i indicates communication from the central server to institute i.

The prediction functions for the weight update are defined as:

W̅₋ᵢ^{(t)}=g(Wᵢ^{(t)}, . . . ,Wᵢ⁽¹⁾,W₋ᵢ^{(t-1)}, . . . ,W₋ᵢ⁽¹⁾;θᵢ^{(t)}) Equation (3)

W̅ᵢ^{(t)}=h(Wᵢ^{(t-1)}, . . . ,Wᵢ⁽¹⁾,W₋ᵢ^{(t-1)}, . . . ,W₋ᵢ⁽¹⁾;ϕᵢ^{(t)}) Equation (4)

where W̅₋ᵢ^{(t)} is the predicted global weight update that institute i expects to receive from the central server, W̅ᵢ^{(t)} is the predicted local weight update that the central server expects to receive from institute i, W₋ᵢ^{(t-1)}, . . . , W₋ᵢ⁽¹⁾ and Wᵢ^{(t)}, . . . , Wᵢ⁽¹⁾ are the previous and actual weight updates received on the central server and institute i respectively, and θ^{(t)} and ϕ^{(t)} are parameters sent together with the weight update residual.

Compared with Equation (1), the calculation of the predicted global weight update W̅₋ᵢ^{(t)} uses previously received weight updates on institute i. Thus, the global weight update residuals sent from the central server to each institute can be different.

In this framework, the central server has copies of the local models on (used by) the institutes.

Table 3 shows the operations and communication on the central server and institute i for one iteration based on framework 2. The notations used in Table 3 are:

M⁽⁰⁾: initial weights of the model
M^{(t)}: global model at after iteration t
Mᵢ^{(t)}: local model at institute i after iteration t
W̅₋ᵢ^{(t)}: predicted global weight update on institute i
\tilde{W}₋ᵢ^{(t)}: actual global weight update residual sent from the central server to institute i
Fᵢ^{(t)}: intended local weight update at institute i after the training of model Mᵢ^{(t-1)}
M̅ᵢ^{(t)}: predicted local weight update from institute i
M̅ᵢ^{(t)}: actual local weight update residual sent from institute i to the central server
G^{(t)}: global weight update at the central server after updates from all institutes are aggregated
Wᵢ^{(t)}: actual local weight update on institute i
Hᵢ^{(t)}: adjusted local weight update for institute i
Dᵢ^{(t)}: intended global weight update for institute i
W₋ᵢ^{(t)}: actual global weight update for institute i
ϕᵢ^{(t)}: parameters to calculate W̅ᵢ^{(t)}
θᵢ^{(t)} parameters to calculate W̅₋ᵢ^{(t)}
q(⋅): a compress operation, for example, sparsification, quantization g(⋅),h(⋅): prediction function defined in Equations (3) and (4).

TABLE 3

| | Central Server | Communication | Institute i |
|---|---|---|---|
| Initialization | Initialize M⁽⁰⁾ | | |
| | | → M⁽⁰⁾ | |
| Iteration i | initial state: | | initial state: Mᵢ^{(t-1)} |
| | M^{(t-1)}, Mᵢ^{(t-1)} | | |
| | | | Train M^{(t-1)} to get |
| | | | weight update Fᵢ^{(t)} |
| | | | Calculate W̅ᵢ^{(t)}, |
| | | | ϕᵢ^{(t)} |
| | | | \tilde{W}ᵢ^{(t)} = |
| | | | q(Fᵢ^{(t)} − W̅ᵢ^{(t)}) |
| | | ← \tilde{W}ᵢ^{(t)}, ϕᵢ^{(t)} | |
| | W̅ᵢ^{(t)} = h(•, ϕᵢ^{(t)}) | | |
| | Wᵢ^{(t)} = W̅ᵢ^{(t)} + \tilde{W}ᵢ^{(t)} | | |
| | \hat{M}ᵢ^{(t)} = | | |
| | Mᵢ^{(t-1)} + Wᵢ^{(t)} | | |
| | Hᵢ^{(t)} = \hat{M}ᵢ^{(t)} − M^{(t-1)} | | |
| | Aggregate updates | | |
| | G^{(t)} = | | |
| | f(H₁^{(t)}, . . . , H_{K}^{(t)}) | | |
| | M^{(t)} = M^{(t-1)} + G^{(t)} | | |
| | D₋ᵢ^{(t)} = M^{(t)} − Mᵢ^{(t-1)} | | |
| | Calculate | | |
| | W̅₋ᵢ^{(t)}, θᵢ^{(t)} | | |
| | \tilde{W}₋ᵢ^{(t)} = | | |
| | q(D₋ᵢ^{(t)} − W̅₋ᵢ^{(t)} | | |
| | W₋ᵢ^{(t)} = | | |
| | W̅₋ᵢ^{(t)} + \tilde{W}₋ᵢ^{(t)} | | |
| | Mᵢ^{(t)} = | | |
| | Mᵢ^{(t-1)} + W₋ᵢ^{(t)} | | |
| | | → \tilde{W}₋ᵢ^{(t)}, θᵢ^{(t)} | |
| | | | W̅₋ᵢ^{(t)} = g(•; θᵢ^{(t)}) |
| | | | W₋ᵢ^{(t)} = |
| | | | W̅₋ᵢ^{(t)} + \tilde{W}₋ᵢ^{(t)} |
| | | | Mᵢ^{(t)} = |
| | | | Mᵢ^{(t-1)} + W₋ᵢ^{(t)} |
| Iteration i + 1 | | | Train M^{(t)} to get weight update Fᵢ^{(t+1)} |

Table 3 shows the operation and communication of a distributed or federated learning system that is based on the proposed asynchronized weight updates residual communication.

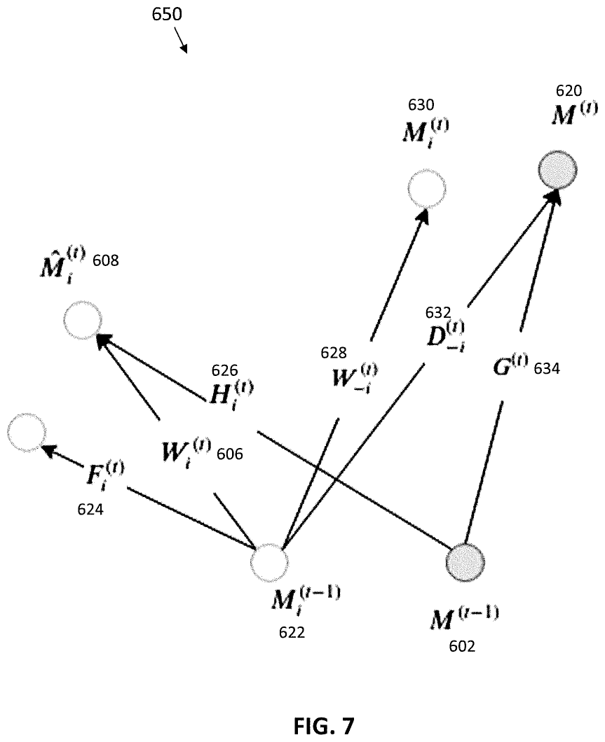

FIG. 7 shows the model states and weight updates of a distributed or federated learning system 650 based on the asynchronized framework at iteration t. Note that after iteration t, the local model on each institute may be different than the global model on the central server. For simplicity, only institute i is shown in FIG. 7.

Shown in FIG. 7 is the model after iteration t−1 (M^{(t-1)} 602), as well as the model after iteration t (M^{(t)} 620). FIG. 7 further shows the model of institute i after iteration t−1, Mᵢ^{(t-1)} 622, the local model update \hat{M}ᵢ^{(t)} 608 of institute i at iteration t, and the model of institute i after iteration t, Mᵢ^{(t)} 630. FIG. 7 further shows Fᵢ^{(t)} 624, or the intended local weight update at institute i after the training of model Mᵢ^{(t-1)} 622, the actual local weight update Wᵢ^{(t)} 606 of institute i at iteration t, the adjusted local weight update for institute i, Hᵢ^{(t)} 626, the intended global weight update for institute i, D₋ᵢ^{(t)} 632, the actual global weight update W₋ᵢ^{(t)} 628 for institute i at iteration t, and the global weight update at the central server after updates from all institutes are aggregated, G^{(t)} 634.

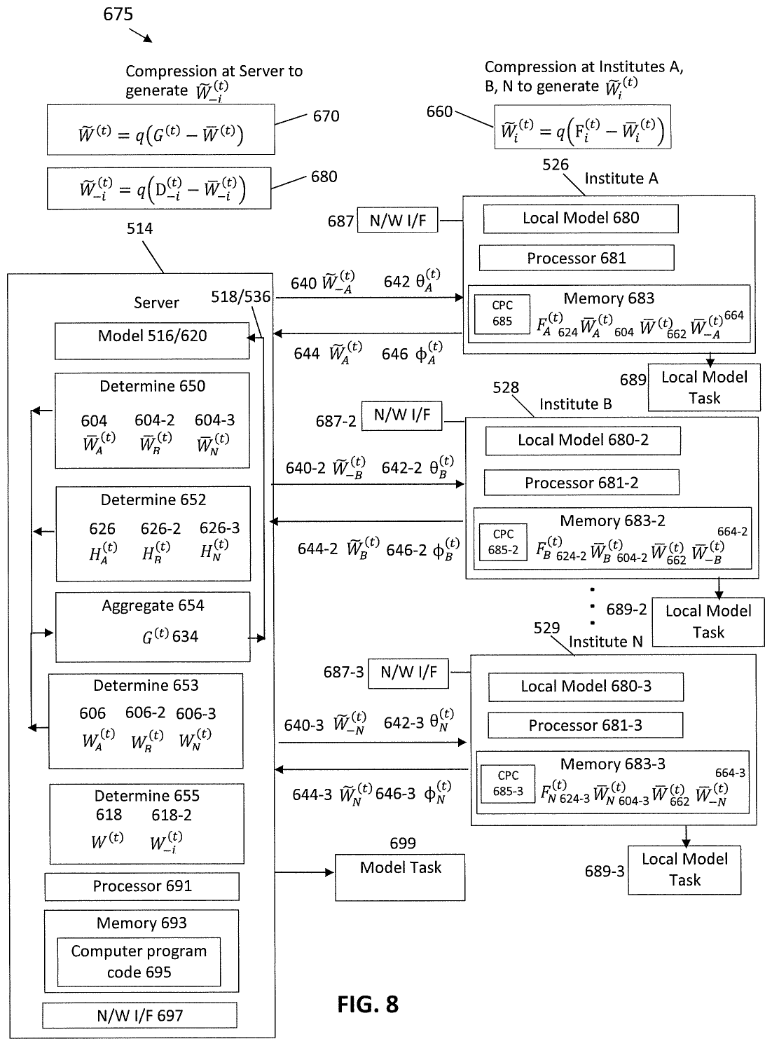

FIG. 8 shows another federated learning system architecture 675 and the communication of weight residuals between the central server and institutes.

As shown in FIG. 8, the server apparatus 514 comprises at least one processor 691; and at least one non-transitory or transitory memory 693 including computer program code 695; wherein the at least one memory 693 and the computer program code 695 are configured to, with the at least one processor 691, cause the server apparatus 514 at least to: receive a plurality of compressed residual local weight updates (\tilde{W}_{A}^{(t)} 644, \tilde{W}_{B}^{(t)} 644-2, \tilde{W}_{N}^{(t)} 644-3) from a plurality of respective institutes (526, 528, 529) with a plurality of a respective at least one first parameter (ϕ_{A}^{(t)} 646, ϕ_{B}^{(t)} 646-2, ϕ_{N}^{(t)} 646-3), the at least one first parameter (ϕ_{A}^{(t)} 646, ϕ_{B}^{(t)} 646-2, ϕ_{N}^{(t)} 646-3) used to determine 650 a plurality of respective predicted local weight updates (W̅_{A}^{(t)} 604, W̅_{B}^{(t)} 604-2, W̅_{N}^{(t)} 604-3); determine (653, 652) a plurality of local weight updates (W_{A}^{(t)} 606, W_{B}^{(t)} 606-2, W_{N}^{(t)} 606-3) or a plurality of adjusted local weight updates (H_{A}^{(t)} 626, H_{B}^{(t)} 626-2, H_{N}^{(t)} 626-3) based on the plurality of compressed residual local weight updates (\tilde{W}_{A}^{(t)} 644, \tilde{W}_{B}^{(t)} 644-2, \tilde{W}_{N}^{(t)} 644-3) and the plurality of respective predicted local weight updates (W̅_{A}^{(t)} 604, W̅_{B}^{(t)} 604-2, W̅_{N}^{(t)} 604-3); aggregate (654) the plurality of determined local weight updates (W_{A}^{(t)} 606, W_{B}^{(t)} 606-2, W_{N}^{(t)} 606-3) or the plurality of adjusted local weight updates (H_{A}^{(t)} 626, H_{B}^{(t)} 626-2, H_{N}^{(t)} 626-3) to generate an intended global weight update (G^{(t)} 634), and update (518/536) a model (516/620) on a server (514) based at least on the intended global weight update (G^{(t)} 634), the model (516/620) used to perform at least one task (699); and transfer at least one compressed residual global weight update (\tilde{W}_{-A}^{(t)} 640, \tilde{W}_{-B}^{(t)} 640-2, \tilde{W}_{-N}^{(t)} 640-3) to the plurality of institutes (526, 528, 529) with at least one second parameter (θ_{A}^{(t)} 642, θ_{B}^{(t)} 642-2, θ_{N}^{(t)} 642-3), the at least one second parameter (θ_{A}^{(t)} 642, θ_{B}^{(t)} 642-2, θ_{N}^{(t)} 642-3) used to determine at least one predicted global weight update (W̅^{(t)} 662, W̅_{-A}^{(t)} 664, W̅_{-B}^{(t)} 664-2, W̅_{-N}^{(t)} 664-3). The server 514 comprises N/W I/F 697.

As shown in FIG. 8, the institute apparatuses (526, 528, 529) comprise at least one processor (681, 681-2, 681-3); and at least one non-transitory or transitory memory (683, 683-2, 683-3) including computer program code (685, 685-2, 685-3); wherein the at least one memory (683, 683-2, 683-3) and the computer program code (685, 685-2, 685-3) are configured to, with the at least one processor (681, 681-2, 681-3), cause the apparatus (526, 528, 529) at least to: generate a compressed residual local weight update (\tilde{W}_{A}^{(t)} 644, \tilde{W}_{B}^{(t)} 644-2, \tilde{W}_{N}^{(t)} 644-3) after compressing a difference (660) between an intended local weight update (F_{A}^{(t)} 624, F_{B}^{(t)} 624-2, F_{N}^{(t)} 624-3) and a predicted local weight update (W̅_{A}^{(t)} 604, W̅_{B}^{(t)} 604-2, W̅_{N}^{(t)} 604-3); transfer the compressed residual local weight update (\tilde{W}_{A}^{(t)} 644, \tilde{W}_{B}^{(t)} 644-2, \tilde{W}_{N}^{(t)} 644-3) from an institute (526, 528, 529) to a server (514) with at least one first parameter (ϕ_{A}^{(t)} 646, ϕ_{B}^{(t)} 646-2, ϕ_{N}^{(t)} 646-3), the at least one first parameter (ϕ_{A}^{(t)} 646, ϕ_{B}^{(t)} 646-2, ϕ_{N}^{(t)} 646-3) used to determine the predicted local weight update (W̅_{A}^{(t)} 604, W̅_{B}^{(t)} 604-2, W̅_{N}^{(t)} 604-3); receive a compressed residual global weight update (\tilde{W}_{-A}^{(t)} 640, \tilde{W}_{-B}^{(t)} 640-2, \tilde{W}_{-N}^{(t)} 640-3) from the server (514) with at least one second parameter (θ_{A}^{(t)} 642, θ_{B}^{(t)} 642-2, θ_{N}^{(t)} 642-3), the at least one second parameter (θ_{A}^{(t)} 642, θ_{B}^{(t)} 642-2, θ_{N}^{(t)} 642-3) used to determine a predicted global weight update (W̅^{(t)} 662, W̅_{-A}^{(t)} 664, W̅_{-B}^{(t)} 664-2, W̅_{-N}^{(t)} 664-3); and update a local model (680, 680-2, 680-3) on the institute (526, 528, 529) based in part on the compressed residual global weight update (\tilde{W}_{-A}^{(t)} 640, \tilde{W}_{-B}^{(t)} 640-2, \tilde{W}_{-N}^{(t)} 640-3), the local model (680, 680-2, 680-3) used to perform at least one task (689, 689-2, 689-3). The institutes (526, 528, 529) also comprise respective N/W I/Fs (687, 687-2, 687-3).

Also shown in FIG. 8 in the compression at the server 514 to generate the residual global update when the institutes receive the same update 670 and when the institutes receive a different update 680 (even though for the 680 calculation two or more institutes may receive the same update, e.g. an update having the same value). At 670, the update \tilde{W}^{(t)} (640, 640-2, 640-3) is generated by compressing using compression function q(⋅) a difference between the intended global weight update G^{(t)} and the predicted global weight update W̅^{(t)}. The compression 670 takes place within CPC 695. At 680, the update \tilde{W}ᵢ^{(t)} (640, 640-2, 640-3) is generated by compressing using compression function q(⋅) a difference between the intended global weight update for an institute D₋ᵢ^{(t)} and the predicted local weight update W̅₋ᵢ^{(t)} (604, 604-2, 604-3) for an institute. The compression 680 takes place within CPC 695.

The intention is to use ‘tilde’ notation (\tilde{ }) for the data transferred between the server and institutes. So, for the baseline system, it is the actual weight update. And for the system/method described herein it represents the actual weight update residual.

Autoregressive Model for Weight Update

In one embodiment, the prediction functions h(⋅) and g(⋅) are defined as a linear autoregressive model of order p. For framework 1, functions g(⋅) and h(⋅) are defined as

W̅^{(t)}=c^{(t)}+Σₖ₌₁^{p}μₖ^{(t)}W^{(t-k)} Equation (5)

W̅ᵢ^{(t)}=c^{(t)}+Σₖ₌₁^{p}λₖ^{(t)}Wᵢ^{(t-k)}+Σₖ₌₁^{p}μₖ^{(t)}W^{(t-k)} Equation (6)

and for framework 2, functions g(⋅) and h(⋅) are defined as

W̅₋ᵢ^{(t)}=c^{(t)}+Σₖ₌₀^{p}λₖ^{(t)}Wᵢ^{(t-k)}+Σₖ₌₁^{p}μₖ^{(t)}W₋ᵢ^{(t-k)} Equation (7)

W̅₋ᵢ^{(t)}=c^{(t)}+Σₖ₌₁^{p}λₖ^{(t)}Wᵢ^{(t-k)}+Σₖ₌₁^{p}μₖ^{(t)}W₋ᵢ^{(t-k)} Equation (8)

In another embodiment, functions h(⋅) and g(⋅) are defined as nonlinear functions with some coefficients.

The coefficients c^{(t)}, λₖ^{(t)} and μₖ^{(t)} can be determined by optimizing (e.g., minimizing), but not limited to, the mean squared error (MSE) loss of the predicted value and the intended value, for example,

L_{W}=∥G^{(t)}−W̅^{(t)}∥₂² Equation (9)

L_{W}_{ᵢ}=∥Fᵢ^{(t)}−W̅ᵢ^{(t)}∥₂² Equation (10)

In another embodiment, the coefficients c^{(t)}, λₖ^{(t)} and μₖ^{(t)} can be determined by optimizing (e.g., minimizing) a rate distortion loss function, for example,

L_{W}=αR(G^{(t)}−W̅^{(t)})+∥G^{(t)}−W̅^{(t)}∥₂² Equation (11)

L_{W}_{ᵢ}=αR(Fᵢ^{(t)}−W̅ᵢ^{(t)})+∥Fᵢ^{(t)}−W̅ᵢ^{(t)}∥₂² Equation (12)

where R(⋅) is the rate loss, i.e., the code length to encode the residuals after quantization operation using an entropy encoding method, or an approximation thereof.

Yet in another embodiment, the compression function q(⋅) can be used in the rate loss term and/or the MSE loss term in Equations (9, 10, 11, 12) to determine the coefficients. For example, Equations (9) and (10) become

L_{W}=∥q(G^{(t)}−W̅^{(t)})∥₂² Equation (13)

L_{W}_{ᵢ}=∥q(Fᵢ^{(t)}−W̅ᵢ^{(t)})∥₂² Equation (14)

In one embodiment, the local weight updates may be obtained in such a way that the term in Equation (10), or the term in Equation (12), or the term in Equation (14) can be minimized with respect to the coefficients in a more effective way, for example in terms of number of optimization iterations needed to achieve a desirable prediction accuracy, or in terms of rate-distortion performance. This may be implemented within a meta-learning framework, where an inner loop determines the prediction coefficients, and the outer loop determines the local weight-updates based on the performance of the prediction when using the determined prediction coefficients.

In yet another embodiment, the local weight updates may be obtained by using an additional term in the loss function which encourages the weight-updates to be more predictable. For example, the additional term may encourage the weight-updates to be close to be small in magnitude. In another example, the additional term may encourage the weight-updates to have less entropy.

Parameters θ^{(t)} and ϕ^{(t)}

Parameters θ^{(t)} and ϕ^{(t)} define the prediction method and the coefficients to calculate the predicted weight update, for example, c^{(t)}, λₖ^{(t)} and μₖ^{(t)} in a linear autoregressive model. A sender determines the prediction method and the corresponding coefficients by optimizing the loss function defined in Equations (9, 10, 11, 12, 13, 14). The following prediction methods are described herein: i) no prediction, ii) previous coefficients, iii) receiver's autoregressive model coefficients, and iv) sender's autoregressive model coefficients.

In the no prediction method, no prediction is performed, i.e., the predicted value is zero. No coefficients are transferred.

In the previous coefficients method, the prediction is performed using the coefficients of a previous prediction. Parameter θ and ϕ contains an integer number that indicates the distance from the iteration at which the coefficients are used to the current iteration. For example, distance 1 means the coefficients from the previous iteration are used.

In the receiver's autoregressive model coefficients mode, the receiver assumes the weight updates are generated by an autoregressive linear model as defined in the description of the autoregressive model for weight update. The coefficients are determined using the historical data. Taking W as an example, W̅^{(t)} is modeled as

$${\overline{W}}^{( t )} = c + {\sum }_{k = 1}^{p} {λ}_{k} {W}_{i}^{( t - k )} + {\sum }_{k = 1}^{p} {μ}_{k} {W}^{( t - k )} .$$

Coefficients c^{(t)}, λₖ^{(t)} and μₖ^{(t)} can be determined by minimizing the loss function up to iteration t−1, i.e.

L=Σₖ₌₁^{t-1}∥W^{k}−W̅^{k}∥₂².

Parameters θ^{(t)} and ϕ^{(t)} contain an integer number that indicates the distance from the iteration that the coefficients are derived to the current iteration.

In the sender's autoregressive model coefficients mode, the coefficients c^{(t)}, λₖ^{(t)} and μₖ^{(t)} are calculated by the sender and sent to the receiver. The receiver calculates the predicted weight update using the provided coefficients.

In another embodiment, the coefficients are compressed, for example, quantized, before sending to a receiver.

Yet in another embodiment, the sender sends the residuals of the coefficients, i.e. the difference compared to previous coefficients.

Yet in another embodiment, the sender sends the residuals of the coefficients to the coefficients determined by the “receiver's autoregressive model coefficients” method.

Yet in another embodiment, the sender sends the random seeds to calculate the predicted weight update if a random process is involved.

Residual of Discrete Weight Update

In some setups, the intended weight updates and the predicted weight updates are in discrete values, for example, when the model is discrete or a quantization to the weight update is applied after each training step. In that case, the residual of the weight updates are calculated by a cyclic modulo operator, defined as

\tilde{W}=mod(W−W̅+q,q),

where W is the intended weight updates, W̅ is the predicted weight updates, q is the quantization level of W and W̅, i.e., W,W̅∈{0, . . . , q}, and mod(x,q) is the modulo function that returns the remainder of the division of x by q. Actual weight updates, that is equal to the intended weight updates, are calculated by

W=mod(W̅+\tilde{W},q).

Model Partition

The proposed compression mechanism described method can be applied separately to parts of a deep neural network. A deep neural network is first partitioned into multiple parts. The partition may be performed in a structural basis, functional basis, or a combination of the two. A structure-based partition divides the network by layers, groups of layers, or other structural concepts. A functional-based partition divides the network according to the function of each component, for example, weights for convolution kernels, weights for fully connected layers, bias, parameters for normalization operators, etc.

Each part of the network may apply a different compression mechanism, or be compressed separately, for example with its own prediction method and corresponding coefficients.

In one embodiment, the partition of the neural network is performed before the training and shared among the central server and institutes.

In another embodiment, the partition of the neural network can be determined by the sender at each iteration. The partition information is sent to receivers together with compression parameters and residual data.

Yet in another embodiment, the actual weight updates and the parameters to calculate the predicted weight updates of some parts of the model are used to calculate the predicted weight updates of other parts of the model. For example, model M is partitioned into 3 parts A, B, and C. The predicted weight updates are W̅_{A}, W̅_{B}, and W̅_{C}, respectively. The actual weight updates are W_{A}, W_{B}, and W_{C}, respectively. The parameters to calculate the predicted weight updates are θ_{A}, θ_{B}, and θ_{C}, respectively. With this embodiment, W_{A} and θ_{A}, together with other variables used in equations (1-4), are used to calculate W̅_{B}; W_{A}, θ_{A}, W_{B}, and θ_{B}, together with other variables used in equation (1-4), are used to calculate W̅_{C}.

Yet in another embodiment, the sender determines the order of the parts wherein the residual weight updates and corresponding parameters are sent. The order is determined by optimizing the overall compression performance of the weight updates of the whole model. The order is transferred to the receiver together with the residual weight updates.

The described method may be part of MPEG compression of neural networks for multimedia content description and analysis standards and associated products. The described method may be part of bitstream exchanges between a central server and institutes.

There are several technical effects of the examples described herein, including lower transmission bandwidth and less storage demand of weight update data for distributed or federated learning systems. The compression ratio (original size divided by the compressed size) may vary, for example an estimate is that the compression ratio is between 2 and 100. Another potential technical effect may be a higher accuracy of the global updated neural network given the same number of bits required to represent the exchanged weight updates.

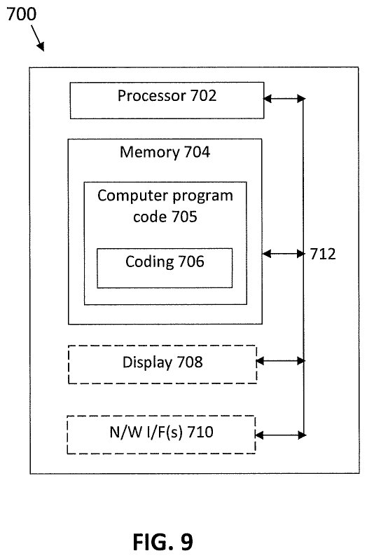

FIG. 9 is an example apparatus 700, which may be implemented in hardware, configured to implement a compression framework for federated learning with predictive compression paradigm, based on the examples described herein. The apparatus 700 comprises a processor 702, at least one non-transitory or transitory memory 704 including computer program code 705, wherein the at least one memory 704 and the computer program code 705 are configured to, with the at least one processor 702, cause the apparatus to implement coding 706 to compress weight updates of a model such as a neural network, based on the examples described herein. The apparatus 700 optionally includes a display 708 that may be used to display content during ML/task/machine/NN processing or rendering. The apparatus 700 optionally includes one or more network (N/W) interfaces (I/F(s)) 710. The N/W I/F(s) 710 may be wired and/or wireless and communicate over the Internet/other network(s) via any communication technique. The N/W I/F(s) 710 may comprise one or more transmitters and one or more receivers. The N/W I/F(s) 710 may comprise standard well-known components such as an amplifier, filter, frequency-converter, (de)modulator, and encoder/decoder circuitry(ies) and one or more antennas. In some examples, the processor 702 is configured to implement coding 706 without use of memory 704.

The memory 704 may be implemented using any suitable data storage technology, such as semiconductor based memory devices, flash memory, magnetic memory devices and systems, optical memory devices and systems, fixed memory and removable memory. The memory 704 may comprise a database for storing data. Interface 712 enables data communication between the various items of apparatus 700, as shown in FIG. 9. Interface 712 may be one or more buses, or interface 712 may be one or more software interfaces configured to pass data within computer program code 705 or between the items of apparatus 700. For example, the interface 712 may be an object-oriented interface in software, or the interface 712 may be one or more buses such as address, data, or control buses, and may include any interconnection mechanism, such as a series of lines on a motherboard or integrated circuit, fiber optics or other optical communication equipment, and the like. The apparatus 700 need not comprise each of the features mentioned, or may comprise other features as well. The apparatus 700 may be an embodiment of apparatuses shown in FIG. 1, FIG. 2, FIG. 3, FIG. 4, FIG. 5, FIG. 6, FIG. 7, or FIG. 8, including any combination of those. In one example, the apparatus 700 implements the functionality of the central server 514. In another example, the apparatus 700 implements the functionality of one or more institutes (526, 528, and/or 529) In another example, apparatus 700 may combine functionality of the server 514 and one or more of the institutes (526, 528, 529). In another example, the apparatus 700 implements the hardware and functionality of apparatus 50 as depicted in FIG. 1.

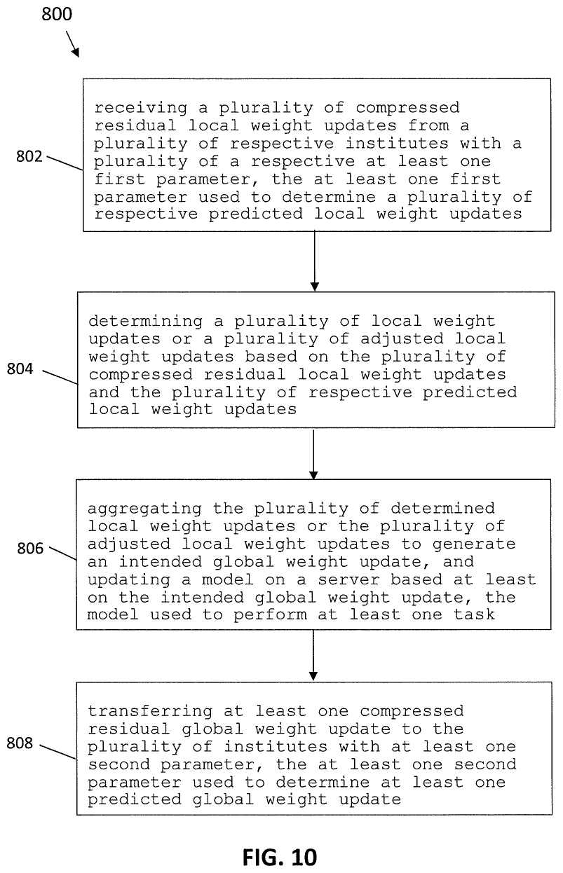

FIG. 10 is an example method 800 to implement a compression framework for federated learning with predictive compression paradigm, based on the examples described herein. At 802, the method includes receiving a plurality of compressed residual local weight updates from a plurality of respective institutes with a plurality of a respective at least one first parameter, the at least one first parameter used to determine a plurality of respective predicted local weight updates. At 804, the method includes determining a plurality of local weight updates or a plurality of adjusted local weight updates based on the plurality of compressed residual local weight updates and the plurality of respective predicted local weight updates. At 806, the method includes aggregating the plurality of determined local weight updates or the plurality of adjusted local weight updates to generate an intended global weight update, and updating a model on a server based at least on the intended global weight update, the model used to perform at least one task. At 808, the method includes transferring at least one compressed residual global weight update to the plurality of institutes with at least one second parameter, the at least one second parameter used to determine at least one predicted global weight update. Method 800 may be implemented with any of the apparatuses depicted in FIG. 1, FIG. 2, FIG. 3, FIG. 4, FIG. 5, FIG. 6, FIG. 7, or FIG. 8, including apparatus 50 or apparatus 700. Method 800 may be implemented by central server 514 or server 514.

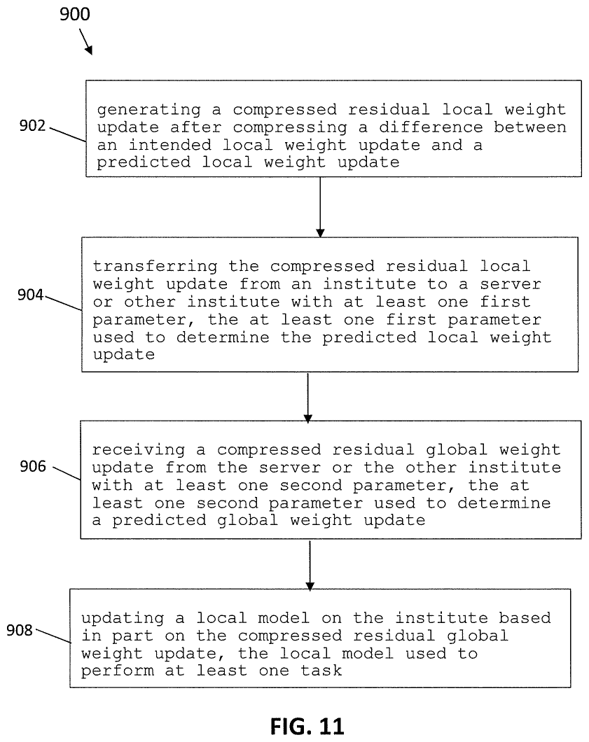

FIG. 11 is another example method 900 to implement a compression framework for federated learning with predictive compression paradigm, based on the examples described herein. At 902, the method includes generating a compressed residual local weight update after compressing a difference between an intended local weight update and a predicted local weight update. At 904, the method includes transferring the compressed residual local weight update from an institute to a server or other institute with at least one first parameter, the at least one first parameter used to determine the predicted local weight update. At 906, the method includes receiving a compressed residual global weight update from the server or the other institute with at least one second parameter, the at least one second parameter used to determine a predicted global weight update. At 908, the method includes updating a local model on the institute based in part on the compressed residual global weight update, the local model used to perform at least one task. Method 900 may be implemented with any of the apparatuses depicted in FIG. 1, FIG. 2, FIG. 3, FIG. 4, FIG. 5, FIG. 6, FIG. 7, or FIG. 8, including apparatus 50 or apparatus 700. Method 900 may be implemented by institute A 526 or institute B 528 or institute N 529.

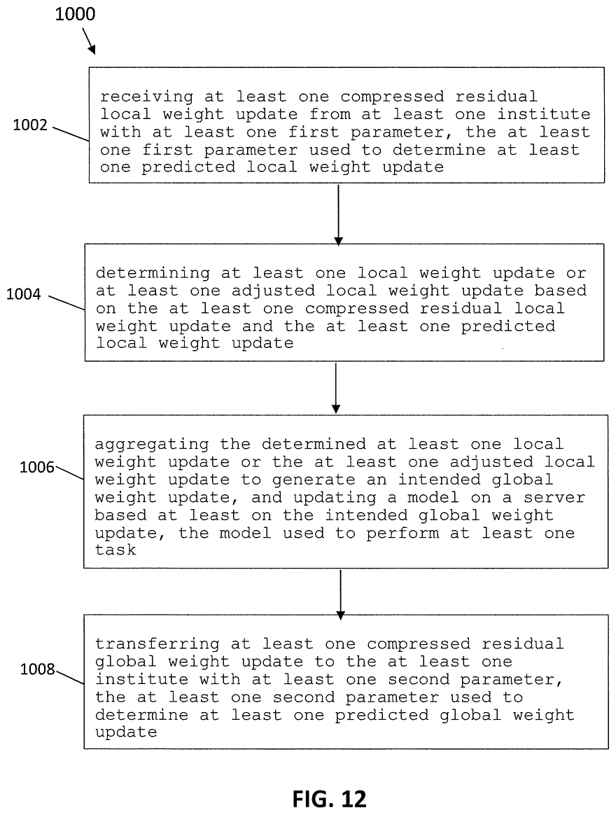

FIG. 12 is another example method 1000 to implement a compression framework for federated learning with predictive compression paradigm, based on the examples described herein. At 1002, the method includes receiving at least one compressed residual local weight update from at least one institute with at least one first parameter, the at least one first parameter used to determine at least one predicted local weight update. At 1004, the method includes determining at least one local weight update or at least one adjusted local weight update based on the at least one compressed residual local weight update and the at least one predicted local weight update. At 1006, the method includes aggregating the determined at least one local weight update or the at least one adjusted local weight update to generate an intended global weight update, and update a model on a server based at least on the intended global weight update, the model used to perform at least one task. At 1008, the method includes transferring at least one compressed residual global weight update to the at least one institute with at least one second parameter, the at least one second parameter used to determine at least one predicted global weight update. Method 1000 may be implemented with any of the apparatuses depicted in FIG. 1, FIG. 2, FIG. 3, FIG. 4, FIG. 5, FIG. 6, FIG. 7, or FIG. 8, including apparatus 50 or apparatus 700. Method 1000 may be implemented by central server 514 or server 514.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

An example apparatus includes at least one processor; and at least one non-transitory memory including computer program code; wherein the at least one memory and the computer program code are configured to, with the at least one processor, cause the apparatus at least to: receive a plurality of compressed residual local weight updates from a plurality of respective institutes with a plurality of a respective at least one first parameter, the at least one first parameter used to determine a plurality of respective predicted local weight updates; determine a plurality of local weight updates or a plurality of adjusted local weight updates based on the plurality of compressed residual local weight updates and the plurality of respective predicted local weight updates; aggregate the plurality of determined local weight updates or the plurality of adjusted local weight updates to generate an intended global weight update, and update a model on a server based at least on the intended global weight update, the model used to perform at least one task; and transfer at least one compressed residual global weight update to the plurality of institutes with at least one second parameter, the at least one second parameter used to determine at least one predicted global weight update.

The apparatus may further include wherein the at least one memory and the computer program code are further configured to, with the at least one processor, cause the apparatus at least to: generate the at least one compressed residual global weight update after compressing a difference between the intended global weight update and the at least one predicted global weight update; generate a global weight update based on the at least one predicted global weight update and the at least one compressed residual global weight update; wherein the model on the server is updated using the global weight update.

The apparatus may further include wherein the plurality of compressed residual local weight updates are a difference between a plurality of local weight updates of the plurality of institutes and a plurality of respective predicted local weight updates of the plurality of institutes.

The apparatus may further include wherein the at least one memory and the computer program code are further configured to, with the at least one processor, cause the apparatus at least to: distribute an initial model to the plurality of institutes.

The apparatus may further include wherein the model on the server is structurally similar to a local model on the respective plurality of institutes.

The apparatus may further include wherein the at least one predicted global weight update is a function of at least one global weight update of a previous iteration and the at least one second parameter transferred with the at least one compressed residual global weight update; and wherein the plurality of respective predicted local weight updates are a function of at least one local weight update of a previous iteration, the at least one global weight update of a previous iteration, and the plurality of the respective at least one first parameter received with the plurality of compressed residual local weight updates.

The apparatus may further include wherein the function for the at least one predicted global weight update or the function for the plurality of respective predicted local weight updates is defined using: respective linear autoregressive models with at least one first coefficient; or respective nonlinear functions with the at least one second coefficient.

The apparatus may further include wherein the at least one first coefficient or the at least one second coefficient is determined based on at least one of: optimizing a mean squared error loss of the at least one predicted global weight update and an intended global weight update, and a mean squared error loss of the plurality of respective predicted local weight updates and an intended plurality of respective predicted local weight updates; optimizing a rate distortion loss function defined as a code length to encode the plurality of compressed residual local weight updates and the at least one compressed residual global weight update after a quantization operation using an entropy encoding method; using a function used to compress the plurality of compressed residual local weight updates within a term of the mean squared error loss and/or a term of the rate distortion loss function; compressing the at least one of the at least one first coefficient or the at least one second coefficient; or using an inner loop to determine the at least one first coefficient for the plurality of respective predicted local weight updates or the at least one second coefficient for the plurality of respective predicted local weight updates, and using an outer loop to determine the plurality of local weight updates based on prediction performance using the at least one first coefficient or the at least one second coefficient.

The apparatus may further include wherein the at least one first parameter or the at least one second parameter: provides an indication that zero should be used as a value for the plurality of respective predicted local weight updates or the at least one predicted global weight update; or provides an indication that the at least one first coefficient or the at least one second coefficient is based on a previous iteration; or provides an indication that the respective linear autoregressive models with at least one first coefficient are used for the plurality of respective predicted local weight updates and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the plurality of compressed residual local weight updates and the at least one compressed residual global weight update have been compressed using sparsification or quantization.

The apparatus may further include wherein the at least one memory and the computer program code are further configured to, with the at least one processor, cause the apparatus at least to: partition a neural network into multiple parts, wherein the neural network is used to determine at least one of: the plurality of respective predicted local weight updates, the plurality of local weight updates, the plurality of adjusted local weight updates, the update to the model on the server, the at least one compressed residual global weight update, the at least one predicted global weight update, or the at least one second parameter.

The apparatus may further include wherein the at least one memory and the computer program code are further configured to, with the at least one processor, cause the apparatus at least to: send information relating to the partition of the neural network to the plurality of institutes.

The apparatus may further include wherein the plurality of local weight updates are obtained using an additional term in a loss function that encourages the plurality of local weight updates to be more predictable.

The apparatus may further include wherein the model on the server is structurally different from at least one local model on the respective plurality of institutes.

The apparatus may further include wherein the at least one memory and the computer program code are further configured to, with the at least one processor, cause the apparatus at least to: generate the at least one compressed residual global weight update, the at least one compressed residual global weight update being for one of the plurality of institutes, after compressing a difference between an intended global weight update for the one of the plurality of institutes and a predicted global weight update for the one of the plurality of institutes; generate a global weight update for the one of the plurality of institutes based on the predicted global weight update for the one of the plurality of institutes and the at least one compressed residual global weight update for the one of the plurality of institutes; and update a model for the one of the plurality of institutes based on the global weight update for the one of the plurality of institutes.

The apparatus may further include wherein the at least one memory and the computer program code are further configured to, with the at least one processor, cause the apparatus at least to: update the model on the server using a model on the server from a previous iteration and the intended global weight update; determine the intended global weight update for the one of the plurality of institutes using the updated model on the server and a respective local model of the plurality of institutes from a previous iteration.

The apparatus may further include wherein the at least one memory and the computer program code are further configured to, with the at least one processor, cause the apparatus at least to: determine a model update for the plurality of institutes using a respective model from a previous iteration and a respective local weight update of the determined plurality of local weight updates; and determine the plurality of adjusted local weight updates using a model for a respective institute of the plurality of institutes of a current iteration and the respective model update.

The apparatus may further include wherein the at least one predicted global weight update is a function of at least one actual local weight update of the plurality of local weight updates, at least one global weight update of a previous iteration, and the at least one second parameter transferred with the at least one compressed residual global weight update; and wherein the plurality of respective predicted local weight updates are a function of at least one local weight update of a previous iteration, the at least one global weight update of a previous iteration, and the plurality of the respective at least one first parameter received with the plurality of compressed residual local weight updates.

The apparatus may further include wherein the function for the at least one predicted global weight update or the function for the plurality of respective predicted local weight updates is defined using: respective linear autoregressive models with at least one first coefficient; or respective nonlinear functions with the at least one second coefficient.

The apparatus may further include wherein the at least one first coefficient or the at least one second coefficient is determined based on at least one of: optimizing a mean squared error loss of the at least one predicted global weight update and an intended global weight update, and a mean squared error loss of the plurality of respective predicted local weight updates and an intended plurality of respective predicted local weight updates; optimizing a rate distortion loss function defined as a code length to encode the plurality of compressed residual local weight updates and the at least one compressed residual global weight update after a quantization operation using an entropy encoding method; using a function used to compress the plurality of compressed residual local weight updates within a term of the mean squared error loss and/or a term of the rate distortion loss function; compressing the at least one of the at least one first coefficient or the at least one second coefficient; or using an inner loop to determine the at least one first coefficient for the plurality of respective predicted local weight updates or the at least one second coefficient for the plurality of respective predicted local weight updates, and using an outer loop to determine the plurality of local weight updates based on prediction performance using the at least one first coefficient or the at least one second coefficient.

The apparatus may further include wherein the at least one first parameter or the at least one second parameter: provides an indication that zero should be used as a value for the plurality of respective predicted local weight updates or the at least one predicted global weight update; or provides an indication that the at least one first coefficient or the at least one second coefficient is based on a previous iteration; or provides an indication that the respective linear autoregressive models with at least one first coefficient are used for the plurality of respective predicted local weight updates and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the at least one memory and the computer program code are further configured to, with the at least one processor, cause the apparatus at least to: generate the at least one compressed residual global weight update based on the intended global weight update and the at least one predicted global weight update; wherein the at least one compressed residual global weight update is determined with a modulo operation that returns a remainder of a term divided with a quantization level; wherein the term is the at least one predicted global weight update subtracted from the intended global weight update added to the quantization level; and wherein the at least one predicted global weight update is a first discrete value determined with the quantization level, and the intended global weight update is a second discrete value determined with the quantization level.

The apparatus may further include wherein the plurality of local weight updates are determined with a modulo operation that returns a remainder of a term divided with a quantization level; wherein the term is the plurality of predicted local weight updates added to the plurality of respective compressed residual local weight updates.

The apparatus may further include wherein the at least one memory and the computer program code are further configured to, with the at least one processor, cause the apparatus at least to: generate a global weight update based on the at least one predicted global weight update and the at least one compressed residual global weight update; wherein the global weight update is determined with a modulo operation that returns the remainder of term divided with a quantization level; wherein the term is the at least one predicted global weight update added to the at least one compressed residual global weight update; and wherein the model on the server is updated using the global weight update, and the model is discrete or a quantization to the global weight update.

The apparatus may further include wherein the at least one memory and the computer program code are further configured to, with the at least one processor, cause the apparatus at least to: partition the at least one predicted global weight update into two or more parts; partition the at least one second parameter into two or more parts respectively corresponding to the two or more parts of the at least one predicted global weight update; and generate a first part of a global weight update based on a first part of the predicted global weight update.

The apparatus may further include wherein the at least one memory and the computer program code are further configured to, with the at least one processor, cause the apparatus at least to: determine a second part of the at least one predicted global weight update using the first part of the global weight update, and a first part of the at least one second parameter.

The apparatus may further include wherein the at least one memory and the computer program code are further configured to, with the at least one processor, cause the apparatus at least to: determine the second part of the at least one predicted global weight update using at least one other variable used to determine the at least one predicted global weight update.

The apparatus may further include wherein the at least one memory and the computer program code are further configured to, with the at least one processor, cause the apparatus at least to: generate a second part of the global weight update based on a second part of the at least one predicted global weight update; and determine a third part of the at least one predicted global weight update using the first part of the global weight update, the first part of the at least one second parameter, the second part of the global weight update, and a second part of the at least one second parameter.

The apparatus may further include wherein the at least one memory and the computer program code are further configured to, with the at least one processor, cause the apparatus at least to: determine the third part of the at least one predicted global weight update using at least one other variable used to determine the at least one predicted global weight update.

The apparatus may further include wherein the at least one memory and the computer program code are further configured to, with the at least one processor, cause the apparatus at least to: partition one of the plurality of predicted local weight updates into two or more parts; partition the at least one first parameter into two or more parts respectively corresponding to the two or more parts of the one of the plurality of predicted local weight updates; and generate a first part of the one of the plurality of local weight updates based on a first part of the one of the plurality of predicted local weight updates.

The apparatus may further include wherein the at least one memory and the computer program code are further configured to, with the at least one processor, cause the apparatus at least to: determine a second part of the one of the plurality of predicted local weight updates using the first part of the one of the plurality of local weight updates, and a first part of the at least one first parameter.

The apparatus may further include wherein the at least one memory and the computer program code are further configured to, with the at least one processor, cause the apparatus at least to: determine the second part of the one of the plurality of predicted local weight updates using at least one other variable used to determine the one of the plurality of predicted local weight updates.

The apparatus may further include wherein the at least one memory and the computer program code are further configured to, with the at least one processor, cause the apparatus at least to: generate a second part of the one of the plurality of local weight updates based on a second part of the one of the plurality of predicted local weight updates; and determine a third part of the one of the plurality of predicted local weight updates using the one of the plurality of local weight updates, the first part of the at least one first parameter, the second part of the one of the plurality of local weight updates, and a second part of the at least one first parameter.

The apparatus may further include wherein the at least one memory and the computer program code are further configured to, with the at least one processor, cause the apparatus at least to: determine the third part of the at least one predicted global weight update using at least one other variable used to determine the at least one predicted global weight update.

The apparatus may further include wherein the at least one memory and the computer program code are further configured to, with the at least one processor, cause the apparatus at least to: partition the at least one compressed residual global weight update into two or more parts; partition the at least one second parameter into two or more parts respectively corresponding to the two or more parts of the at least one compressed residual global weight update; determine an order for sending the two or more parts of the at least one compressed residual global weight update and the two or more parts of the at least one second parameter; and transfer, based on the determined order: the order, and/or the two or more parts of the at least one compressed residual global weight update and the two or more parts of the at least one second parameter to the plurality of institutes.

The apparatus may further include wherein the at least one memory and the computer program code are further configured to, with the at least one processor, cause the apparatus at least to: receive a random seed from the plurality of institutes; and determine the plurality of respective predicted local weight updates or the at least one predicted global weight update using the random seed when a random process is involved.

An example apparatus includes at least one processor; and at least one non-transitory memory including computer program code; wherein the at least one memory and the computer program code are configured to, with the at least one processor, cause the apparatus at least to: generate a compressed residual local weight update after compressing a difference between an intended local weight update and a predicted local weight update; transfer the compressed residual local weight update from an institute to a server or other institute with at least one first parameter, the at least one first parameter used to determine the predicted local weight update; receive a compressed residual global weight update from the server or the other institute with at least one second parameter, the at least one second parameter used to determine a predicted global weight update; and update a local model on the institute based in part on the compressed residual global weight update, the local model used to perform at least one task.

The apparatus may further include wherein the at least one memory and the computer program code are further configured to, with the at least one processor, cause the apparatus at least to: train the local model using local data to generate the intended local weight update to the local model on the institute; and train the local model following the update to the local model based in part on the compressed residual global weight update to generate an adjusted local weight update used to update the local model on the institute during a subsequent iteration.

The apparatus may further include wherein the compressed residual global weight update is a compressed difference between an aggregated intended global weight update and a predicted global weight update.

The apparatus may further include wherein the at least one memory and the computer program code are further configured to, with the at least one processor, cause the apparatus at least to: receive an initial model from the server or the other institute as the local model.

The apparatus may further include wherein the local model is structurally similar to a model updated on the server or the other institute that generates a global weight update.

The apparatus may further include wherein the at least one memory and the computer program code are configured to, with the at least one processor, cause the apparatus at least to: determine an actual global weight update based on the predicted global weight update and the compressed residual global weight update; and update the local model using the determined actual global weight update.

The apparatus may further include wherein the predicted global weight update is a function of at least one global weight update of a previous iteration and the at least one second parameter received with the residual global weight update; and wherein the predicted local weight update is a function of at least one local weight update of a previous iteration, the at least one global weight update of a previous iteration, and the at least one first parameter transferred with the compressed residual local weight update.

The apparatus may further include wherein the function for the predicted global weight update or the function for the predicted local weight update is defined using: respective linear autoregressive models with at least one first coefficient; or respective nonlinear functions with the at least one second coefficient.

The apparatus may further include wherein the at least one first coefficient or the at least one second coefficient is determined based on at least one of: optimizing a mean squared error loss of the predicted global weight update and an intended global weight update, and a mean squared error loss of the predicted local weight update and the intended local weight update; optimizing a rate distortion loss function defined as a code length to encode the compressed residual local weight update and the compressed residual global weight update after a quantization operation using an entropy encoding method; using a function used to compress the compressed residual local weight update within a term of the mean squared error loss and/or a term of the rate distortion loss function; compressing the at least one of the at least one first coefficient or the at least one second coefficient; or using an inner loop to determine the at least one first coefficient for the predicted local weight update or the at least one second coefficient for the predicted local weight update, and using an outer loop to determine the intended local weight update based on prediction performance using the at least one first coefficient or the at least one second coefficient.

The apparatus may further include wherein the at least one first parameter or the at least one second parameter: provides an indication that zero should be used as a value for the predicted local weight update or the predicted global weight update; or provides an indication that the at least one first coefficient or the at least one second coefficient is based on a previous iteration; or provides an indication that the respective linear autoregressive models with at least one first coefficient are used for the predicted local weight update and the predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the compressed residual local weight update and the compressed residual global weight update have been compressed using sparsification or quantization.

The apparatus may further include wherein the at least one memory and the computer program code are further configured to, with the at least one processor, cause the apparatus at least to: partition a neural network into multiple parts, wherein the neural network is used to determine at least one of: the compressed residual local weight update, the intended local weight update, the predicted local weight update, the predicted global weight update, the update to the local model on the institute, or the at least one first parameter.

The apparatus may further include wherein the at least one memory and the computer program code are further configured to, with the at least one processor, cause the apparatus at least to: send information relating to the partition of the neural network to the server or the other institute.

The apparatus may further include wherein the intended local weight update is obtained using an additional term in a loss function that encourages the intended local weight update to be more predictable.

The apparatus may further include wherein the local model is structurally different from a model updated on the server or the other institute that generates a global weight update.

The apparatus may further include wherein the at least one memory and the computer program code are further configured to, with the at least one processor, cause the apparatus at least to: train the local model on the institute using local data to generate the intended local weight update to the local model on the institute; and train the local model following the update to the local model based in part on the compressed residual global weight update to generate an intended local weight update used to update the local model on the institute during a subsequent iteration.

The apparatus may further include wherein the predicted global weight update is a function of at least one actual local weight update, at least one global weight update of a previous iteration, and the at least one second parameter received with the residual global weight update; and wherein the predicted local weight update is a function of the at least one local weight update of a previous iteration, the at least one global weight update of a previous iteration, and the at least one first parameter transferred with the compressed residual local weight update.

The apparatus may further include wherein the function for the predicted global weight update or the function for the predicted local weight update is defined using: respective linear autoregressive models with at least one first coefficient; or respective nonlinear functions with the at least one second coefficient.

The apparatus may further include wherein the at least one first coefficient or the at least one second coefficient are determined based on at least one of: optimizing a mean squared error loss of the predicted global weight update and an intended global weight update, and a mean squared error loss of the predicted local weight update and the intended local weight update; optimizing a rate distortion loss function defined as a code length to encode the compressed residual local weight update and the compressed residual global weight update after a quantization operation using an entropy encoding method; using a function used to compress the compressed residual local weight update within a term of the mean squared error loss and/or a term of the rate distortion loss function; compressing the at least one of the at least one first coefficient or the at least one second coefficient; or using an inner loop to determine the at least one first coefficient for the predicted local weight update or the at least one second coefficient for the predicted local weight update, and using an outer loop to determine the intended local weight update based on prediction performance using the at least one first coefficient or the at least one second coefficient.

The apparatus may further include wherein the at least one first parameter or the at least one second parameter: provides an indication that zero should be used as a value for the predicted local weight update or the predicted global weight update; or provides an indication that the at least one first coefficient or the at least one second coefficient is based on a previous iteration; or provides an indication that the respective linear autoregressive models with at least one first coefficient are used for the predicted local weight update and the predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the institute is asynchronized with the server or the other institute.

The apparatus may further include wherein the at least one memory and the computer program code are further configured to, with the at least one processor, cause the apparatus at least to: wherein the compressed residual local weight update is determined with a modulo operation that returns a remainder of a term divided with a quantization level; wherein the term is the predicted local weight update subtracted from the intended local weight update added to the quantization level; wherein the predicted local weight update is a first discrete value determined with the quantization level, and the intended local weight update is a second discrete value determined with the quantization level.

The apparatus may further include wherein the at least one memory and the computer program code are further configured to, with the at least one processor, cause the apparatus at least to: determine an actual global weight update based on the predicted global weight update and the compressed residual global weight update; wherein the actual global weight update is determined with a modulo operation that returns a remainder of a term divided with a quantization level; wherein the term is the predicted global weight update added to the compressed residual global weight update; and update the local model using the determined actual global weight update, and the local model is discrete or a quantization to the actual global weight update.

The apparatus may further include wherein the at least one memory and the computer program code are further configured to, with the at least one processor, cause the apparatus at least to: partition the predicted global weight update into two or more parts; partition the at least one second parameter into two or more parts respectively corresponding to the two or more parts of the predicted global weight update; and generate a first part of a global weight update based on a first part of the predicted global weight update.

The apparatus may further include wherein the at least one memory and the computer program code are further configured to, with the at least one processor, cause the apparatus at least to: determine a second part of the predicted global weight update using the first part of the global weight update, and a first part of the at least one second parameter.

The apparatus may further include wherein the at least one memory and the computer program code are further configured to, with the at least one processor, cause the apparatus at least to: determine the second part of the predicted global weight update using at least one other variable used to determine the predicted global weight update.

The apparatus may further include wherein the at least one memory and the computer program code are further configured to, with the at least one processor, cause the apparatus at least to: generate a second part of the global weight update based on a second part of the predicted global weight update; and determine a third part of the predicted global weight update using the first part of the global weight update, the first part of the at least one second parameter, the second part of the global weight update, and a second part of the at least one second parameter.

The apparatus may further include wherein the at least one memory and the computer program code are further configured to, with the at least one processor, cause the apparatus at least to: determine the third part of the predicted global weight update using at least one other variable used to determine the predicted global weight update.

The apparatus may further include wherein the at least one memory and the computer program code are further configured to, with the at least one processor, cause the apparatus at least to: partition the predicted local weight update into two or more parts; partition the at least one first parameter into two or more parts respectively corresponding to the two or more parts of the predicted local weight update; and generate a first part of the intended local weight update based on a first part of the predicted local weight update.

The apparatus may further include wherein the at least one memory and the computer program code are further configured to, with the at least one processor, cause the apparatus at least to: determine a second part of the predicted local weight update using the first part of the intended local weight update, and a first part of the at least one first parameter.

The apparatus may further include wherein the at least one memory and the computer program code are further configured to, with the at least one processor, cause the apparatus at least to: determine the second part of the predicted local weight update using at least one other variable used to determine the predicted local weight update.

The apparatus may further include wherein the at least one memory and the computer program code are further configured to, with the at least one processor, cause the apparatus at least to: generate a second part of the intended local weight update based on a second part of the predicted local weight update; and determine a third part of the predicted local weight update using the first part of the intended local weight update, the first part of the at least one first parameter, the second part of the intended local weight update, and a second part of the at least one first parameter.

The apparatus may further include wherein the at least one memory and the computer program code are further configured to, with the at least one processor, cause the apparatus at least to: determine the third part of the predicted local weight update using at least one other variable used to determine the predicted local weight update.

The apparatus may further include wherein the at least one memory and the computer program code are further configured to, with the at least one processor, cause the apparatus at least to: partition the compressed residual local weight update into two or more parts; partition the at least one first parameter into two or more parts respectively corresponding to the two or more parts of the compressed residual local weight update; determine an order for sending the two or more parts of the compressed residual local weight update and the two or more parts of the at least one first parameter; and transfer, based on the determined order: the order, and/or the two or more parts of the compressed residual local weight update and the two or more parts of the at least one first parameter to the server or the other institute.

The apparatus may further include wherein the at least one memory and the computer program code are further configured to, with the at least one processor, cause the apparatus at least to: receive a random seed from the server or other institute; and determine the predicted global weight update or the predicted local weight update using the random seed when a random process is involved.

An apparatus includes at least one processor; and at least one non-transitory memory including computer program code; wherein the at least one memory and the computer program code are configured to, with the at least one processor, cause the apparatus at least to: receive at least one compressed residual local weight update from at least one institute with at least one first parameter, the at least one first parameter used to determine at least one predicted local weight update; determine at least one local weight update or at least one adjusted local weight update based on the at least one compressed residual local weight update and the at least one predicted local weight update; aggregate the determined at least one local weight update or the at least one adjusted local weight update to generate an intended global weight update, and update a model on a server based at least on the intended global weight update, the model used to perform at least one task; and transfer at least one compressed residual global weight update to the at least one institute with at least one second parameter, the at least one second parameter used to determine at least one predicted global weight update.

The apparatus may further include wherein the at least one memory and the computer program code are further configured to, with the at least one processor, cause the apparatus at least to: generate the at least one compressed residual global weight update after compressing a difference between the intended global weight update and the at least one predicted global weight update; generate a global weight update based on the at least one predicted global weight update and the at least one compressed residual global weight update; wherein the model on the server is updated using the global weight update.

The apparatus may further include wherein the at least one compressed residual local weight update is a difference between at least one local weight update of the at least one institute and at least one predicted local weight update of the at least one institute.

The apparatus may further include wherein the at least one memory and the computer program code are further configured to, with the at least one processor, cause the apparatus at least to: distribute an initial model to the at least one institute.

The apparatus may further include wherein the model on the server is structurally similar to a local model on the at least one institute.

The apparatus may further include wherein the at least one predicted global weight update is a function of at least one global weight update of a previous iteration and the at least one second parameter transferred with the at least one compressed residual global weight update; and wherein the at least one predicted local weight update is a function of at least one local weight update of a previous iteration, the at least one global weight update of a previous iteration, and the at least one first parameter received with the at least one compressed residual local weight update.

The apparatus may further include wherein the function for the at least one predicted global weight update or the function for the at least one predicted local weight update is defined using: respective linear autoregressive models with at least one first coefficient; or respective nonlinear functions with the at least one second coefficient.

The apparatus may further include wherein the at least one first coefficient or the at least one second coefficient is determined based on at least one of: optimizing a mean squared error loss of the at least one predicted global weight update and an intended global weight update, and a mean squared error loss of the at least one predicted local weight update and an intended at least one predicted local weight update; optimizing a rate distortion loss function defined as a code length to encode the at least one compressed residual local weight update and the at least one compressed residual global weight update after a quantization operation using an entropy encoding method; using a function used to compress the at least one compressed residual local weight update within a term of the mean squared error loss and/or a term of the rate distortion loss function; compressing the at least one of the at least one first coefficient or the at least one second coefficient; or using an inner loop to determine the at least one first coefficient for the at least one predicted local weight update or the at least one second coefficient for the at least one predicted local weight update, and using an outer loop to determine the at least one local weight update based on prediction performance using the at least one first coefficient or the at least one second coefficient.

The apparatus may further include wherein the at least one first parameter or the at least one second parameter: provides an indication that zero should be used as a value for the at least one predicted local weight update or the at least one predicted global weight update; or provides an indication that the at least one first coefficient or the at least one second coefficient is based on a previous iteration; or provides an indication that the respective linear autoregressive models with at least one first coefficient are used for the at least one predicted local weight update and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the at least one compressed residual local weight update and the at least one compressed residual global weight update have been compressed using sparsification or quantization.

The apparatus may further include wherein the at least one memory and the computer program code are further configured to, with the at least one processor, cause the apparatus at least to: partition a neural network into multiple parts, wherein the neural network is used to determine at least one of: the at least one predicted local weight update, the at least one local weight update, the at least one adjusted local weight update, the update to the model on the server, the at least one compressed residual global weight update, the at least one predicted global weight update, or the at least one second parameter.

The apparatus may further include wherein the at least one memory and the computer program code are further configured to, with the at least one processor, cause the apparatus at least to: send information relating to the partition of the neural network to the at least one institute.

The apparatus may further include wherein the at least one local weight update is obtained using an additional term in a loss function that encourages the at least one local weight update to be more predictable.

The apparatus may further include wherein the model on the server is structurally different from at least one local model on the at least one institute.

The apparatus may further include wherein the at least one memory and the computer program code are further configured to, with the at least one processor, cause the apparatus at least to: generate the at least one compressed residual global weight update, the at least one compressed residual global weight update being for one of the at least one institute, after compressing a difference between an intended global weight update for the one of the at least one institute and a predicted global weight update for the one of the at least one institute; generate a global weight update for the one of the at least one institute based on the predicted global weight update for the one of the at least one institute and the at least one compressed residual global weight update for the one of the at least one institute; and update a model for the one of the at least one institute based on the global weight update for the one of the at least one institute.

The apparatus may further include wherein the at least one memory and the computer program code are further configured to, with the at least one processor, cause the apparatus at least to: update the model on the server using a model on the server from a previous iteration and the intended global weight update; and determine the intended global weight update for the one of the at least one institute using the updated model on the server and a respective local model of the at least one institute from a previous iteration.

The apparatus may further include wherein the at least one memory and the computer program code are further configured to, with the at least one processor, cause the apparatus at least to: determine a model update for the at least one institute using a respective model from a previous iteration and a respective local weight update of the determined at least one local weight update; and determine the at least one adjusted local weight update using a model for a respective institute of the at least one institute of a current iteration and the respective model update.

The apparatus may further include wherein the at least one predicted global weight update is a function of at least one actual local weight update of the at least one local weight update, at least one global weight update of a previous iteration, and the at least one second parameter transferred with the at least one compressed residual global weight update; and wherein the at least one predicted local weight update is a function of at least one local weight update of a previous iteration, the at least one global weight update of a previous iteration, and the at least one first parameter received with the at least one compressed residual local weight update.

The apparatus may further include wherein the function for the at least one predicted global weight update or the function for the at least one predicted local weight update is defined using: respective linear autoregressive models with at least one first coefficient; or respective nonlinear functions with the at least one second coefficient.

The apparatus may further include wherein the at least one first coefficient or the at least one second coefficient is determined based on at least one of: optimizing a mean squared error loss of the at least one predicted global weight update and an intended global weight update, and a mean squared error loss of the at least one predicted local weight update and an intended at least one predicted local weight update; optimizing a rate distortion loss function defined as a code length to encode the at least one compressed residual local weight update and the at least one compressed residual global weight update after a quantization operation using an entropy encoding method; using a function used to compress the at least one compressed residual local weight update within a term of the mean squared error loss and/or a term of the rate distortion loss function; compressing the at least one of the at least one first coefficient or the at least one second coefficient; or using an inner loop to determine the at least one first coefficient for the at least one predicted local weight update or the at least one second coefficient for the at least one predicted local weight update, and using an outer loop to determine the at least one local weight update based on prediction performance using the at least one first coefficient or the at least one second coefficient.

The apparatus may further include wherein the at least one first parameter or the at least one second parameter: provides an indication that zero should be used as a value for the at least one respective predicted local weight update or the at least one predicted global weight update; or provides an indication that the at least one first coefficient or the at least one second coefficient is based on a previous iteration; or provides an indication that the respective linear autoregressive models with at least one first coefficient are used for the at least one predicted local weight updates and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the at least one memory and the computer program code are further configured to, with the at least one processor, cause the apparatus at least to: generate the at least one compressed residual global weight update based on the intended global weight update and the at least one predicted global weight update; wherein the at least one compressed residual global weight update is determined with a modulo operation that returns a remainder of a term divided with a quantization level; wherein the term is the at least one predicted global weight update subtracted from the intended global weight update added to the quantization level; and wherein the at least one predicted global weight update is a first discrete value determined with the quantization level, and the intended global weight update is a second discrete value determined with the quantization level.

The apparatus may further include wherein the at least one local weight update is determined with a modulo operation that returns a remainder of a term divided with a quantization level; and wherein the term is the at least one predicted local weight update added to the at least one compressed residual local weight update.

The apparatus may further include wherein the at least one memory and the computer program code are further configured to, with the at least one processor, cause the apparatus at least to: generate a global weight update based on the at least one predicted global weight update and the at least one compressed residual global weight update; wherein the global weight update is determined with a modulo operation that returns the remainder of term divided with a quantization level; wherein the term is the at least one predicted global weight update added to the at least one compressed residual global weight update; and wherein the model on the server is updated using the global weight update, and the model is discrete or a quantization to the global weight update.

The apparatus may further include wherein the at least one memory and the computer program code are further configured to, with the at least one processor, cause the apparatus at least to: partition the at least one predicted global weight update into two or more parts; partition the at least one second parameter into two or more parts respectively corresponding to the two or more parts of the at least one predicted global weight update; and generate a first part of a global weight update based on a first part of the predicted global weight update.

The apparatus may further include wherein the at least one memory and the computer program code are further configured to, with the at least one processor, cause the apparatus at least to: determine a second part of the at least one predicted global weight update using the first part of the global weight update, and a first part of the at least one second parameter.

The apparatus may further include wherein the at least one memory and the computer program code are further configured to, with the at least one processor, cause the apparatus at least to: determine the second part of the at least one predicted global weight update using at least one other variable used to determine the at least one predicted global weight update.

The apparatus may further include wherein the at least one memory and the computer program code are further configured to, with the at least one processor, cause the apparatus at least to: generate a second part of the global weight update based on a second part of the at least one predicted global weight update; and determine a third part of the at least one predicted global weight update using the first part of the global weight update, the first part of the at least one second parameter, the second part of the global weight update, and a second part of the at least one second parameter.

The apparatus may further include wherein the at least one memory and the computer program code are further configured to, with the at least one processor, cause the apparatus at least to: determine the third part of the at least one predicted global weight update using at least one other variable used to determine the at least one predicted global weight update.

The apparatus may further include wherein the at least one memory and the computer program code are further configured to, with the at least one processor, cause the apparatus at least to: partition one of the at least one predicted local weight update into two or more parts; partition the at least one first parameter into two or more parts respectively corresponding to the two or more parts of the one of the at least one predicted local weight update; and generate a first part of the one of the at least one local weight update based on a first part of the one of the at least one predicted local weight update.

The apparatus may further include wherein the at least one memory and the computer program code are further configured to, with the at least one processor, cause the apparatus at least to: determine a second part of the one of the at least one predicted local weight update using the first part of the one of the at least one local weight update, and a first part of the at least one first parameter.

The apparatus may further include wherein the at least one memory and the computer program code are further configured to, with the at least one processor, cause the apparatus at least to: determine the second part of the one of the at least one predicted local weight update using at least one other variable used to determine the one of the at least one predicted local weight update.

The apparatus may further include wherein the at least one memory and the computer program code are further configured to, with the at least one processor, cause the apparatus at least to: generate a second part of the one of the at least one local weight update based on a second part of the one of the at least one predicted local weight update; and determine a third part of the one of the at least one predicted local weight update using the one of the at least one local weight update, the first part of the at least one first parameter, the second part of the one of the at least one local weight update, and a second part of the at least one first parameter.

The apparatus may further include wherein the at least one memory and the computer program code are further configured to, with the at least one processor, cause the apparatus at least to: determine the third part of the at least one predicted global weight update using at least one other variable used to determine the at least one predicted global weight update.

The apparatus may further include wherein the at least one memory and the computer program code are further configured to, with the at least one processor, cause the apparatus at least to: partition the at least one compressed residual global weight update into two or more parts; partition the at least one second parameter into two or more parts respectively corresponding to the two or more parts of the at least one compressed residual global weight update; determine an order for sending the two or more parts of the at least one compressed residual global weight update and the two or more parts of the at least one second parameter; and transfer, based on the determined order: the order, and/or the two or more parts of the at least one compressed residual global weight update and the two or more parts of the at least one second parameter to the at least one institute.

The apparatus may further include wherein the at least one memory and the computer program code are further configured to, with the at least one processor, cause the apparatus at least to: receive a random seed from the at least one institute; and determine the at least one predicted local weight update or the at least one predicted global weight update using the random seed when a random process is involved.

An example apparatus includes at least one processor; and at least one non-transitory memory including computer program code; wherein the at least one memory and the computer program code are configured to, with the at least one processor, cause the apparatus at least to: receive a plurality of compressed residual local weight updates from a plurality of respective institutes; determine a plurality of local weight updates or a plurality of adjusted local weight updates based on the plurality of compressed residual local weight updates and a plurality of respective predicted local weight updates; aggregate the plurality of determined local weight updates or the plurality of adjusted local weight updates to generate an intended global weight update, and update a model on a server based at least on the intended global weight update, the model used to perform at least one task; and transfer at least one compressed residual global weight update to the plurality of institutes.

The apparatus may further include wherein the plurality of compressed residual local weight updates and the at least one compressed residual global weight update have been compressed using sparsification or quantization.

The apparatus may further include wherein the plurality of compressed residual local weight updates are received from the plurality of respective institutes with a plurality of a respective at least one first parameter, the at least one first parameter used to determine a plurality of respective predicted local weight updates; and wherein the at least one compressed residual global weight update is transferred to the plurality of institutes with at least one second parameter, the at least one second parameter used to determine at least one predicted global weight update.

The apparatus may further include wherein the at least one memory and the computer program code are further configured to, with the at least one processor, cause the apparatus at least to: partition the model into two or more parts, wherein actual weight updates and parameters to calculate predicted weight updates of some parts of the model are used to calculate predicted weight updates of other parts of the model.

The apparatus may further include wherein the plurality of compressed residual local weight updates and the at least one compressed residual global weight update are calculated with a cyclic modulo operator.

An example method includes receiving a plurality of compressed residual local weight updates from a plurality of respective institutes; determining a plurality of local weight updates or a plurality of adjusted local weight updates based on the plurality of compressed residual local weight updates and a plurality of respective predicted local weight updates; aggregating the plurality of determined local weight updates or the plurality of adjusted local weight updates to generate an intended global weight update, and updating a model on a server based at least on the intended global weight update, the model used to perform at least one task; and transferring at least one compressed residual global weight update to the plurality of institutes.

An example non-transitory program storage device readable by a machine, tangibly embodying a program of instructions executable by the machine for performing operations is provided, the operations comprising: receiving a plurality of compressed residual local weight updates from a plurality of respective institutes; determining a plurality of local weight updates or a plurality of adjusted local weight updates based on the plurality of compressed residual local weight updates and a plurality of respective predicted local weight updates; aggregating the plurality of determined local weight updates or the plurality of adjusted local weight updates to generate an intended global weight update, and updating a model on a server based at least on the intended global weight update, the model used to perform at least one task; and transferring at least one compressed residual global weight update to the plurality of institutes.

An example apparatus includes at least one processor; and at least one non-transitory memory including computer program code; wherein the at least one memory and the computer program code are configured to, with the at least one processor, cause the apparatus at least to: generate a compressed residual local weight update after compressing a difference between an intended local weight update and a predicted local weight update; transfer the compressed residual local weight update from an institute to a server or other institute; receive a compressed residual global weight update from the server or the other institute; and update a local model on the institute based in part on the compressed residual global weight update, the local model used to perform at least one task.

The apparatus may further include wherein the compressed residual local weight update and the compressed residual global weight update have been compressed using sparsification or quantization.

The apparatus may further include wherein the compressed residual local weight update is transferred from the institute to the server or other institute with at least one first parameter, the at least one first parameter used to determine the predicted local weight update; and wherein the compressed residual global weight update is received from the server or the other institute with at least one second parameter, the at least one second parameter used to determine a predicted global weight update.

The apparatus may further include wherein the at least one memory and the computer program code are further configured to, with the at least one processor, cause the apparatus at least to: partition the local model into two or more parts, wherein actual weight updates and parameters to calculate predicted weight updates of some parts of the local model are used to calculate predicted weight updates of other parts of the local model.

The apparatus may further include wherein the compressed residual local weight update and the compressed residual global weight update are calculated with a cyclic modulo operator.

The apparatus may further include wherein the predicted local weight update is determined as a linear autoregressive function, and a predicted global weight update is determined as a linear autoregressive function.

The apparatus may further include wherein the predicted local weight update is determined as a nonlinear function with at least one first coefficient, and a predicted global weight update is determined as a nonlinear function with at least one second coefficient.

The apparatus may further include wherein the at least one first coefficient or the at least one second coefficient is determined based on at least one of: a mean squared error loss; a rate distortion loss; or a compression function used in the mean squared error loss and/or the rate distortion loss.

The apparatus may further include wherein the compression function is a function used to compress either the compressed residual local weight update or the compressed residual global weight update.

An example method includes generating a compressed residual local weight update after compressing a difference between an intended local weight update and a predicted local weight update; transferring the compressed residual local weight update from an institute to a server or other institute; receiving a compressed residual global weight update from the server or the other institute; and updating a local model on the institute based in part on the compressed residual global weight update, the local model used to perform at least one task.

An example non-transitory program storage device readable by a machine, tangibly embodying a program of instructions executable by the machine for performing operations is provided, the operations comprising: generating a compressed residual local weight update after compressing a difference between an intended local weight update and a predicted local weight update; transferring the compressed residual local weight update from an institute to a server or other institute; receiving a compressed residual global weight update from the server or the other institute; and updating a local model on the institute based in part on the compressed residual global weight update, the local model used to perform at least one task.

An example apparatus includes at least one processor; and at least one non-transitory memory including computer program code; wherein the at least one memory and the computer program code are configured to, with the at least one processor, cause the apparatus at least to: receive at least one compressed residual local weight update from at least one institute; determine at least one local weight update or at least one adjusted local weight update based on the at least one compressed residual local weight update and at least one predicted local weight update; aggregate the determined at least one local weight update or the at least one adjusted local weight update to generate an intended global weight update, and update a model on a server based at least on the intended global weight update, the model used to perform at least one task; and transfer at least one compressed residual global weight update to the at least one institute.

The apparatus may further include wherein the at least one compressed residual local weight update and the at least one compressed residual global weight update have been compressed using sparsification or quantization.

The apparatus may further include wherein the at least one compressed residual local weight update is received from the at least one institute with at least one first parameter, the at least one first parameter used to determine the at least one predicted local weight update; and wherein the at least one compressed residual global weight update is transferred to the at least one institute with at least one second parameter, the at least one second parameter used to determine at least one predicted global weight update.

The apparatus may further include wherein the at least one memory and the computer program code are further configured to, with the at least one processor, cause the apparatus at least to: partition the model into two or more parts, wherein actual weight updates and parameters to calculate predicted weight updates of some parts of the model are used to calculate predicted weight updates of other parts of the model.

The apparatus may further include wherein the at least one compressed residual local weight update and the at least one compressed residual global weight update are calculated with a cyclic modulo operator.

The apparatus may further include wherein the at least one predicted local weight update is determined as a linear autoregressive function, and at least one predicted global weight update is determined as a linear autoregressive function.

The apparatus may further include wherein the predicted local weight update is determined as a nonlinear function with at least one first coefficient, and at least one predicted global weight update is determined as a nonlinear function with at least one second coefficient.

The apparatus may further include wherein the at least one first coefficient or the at least one second coefficient is determined based on at least one of: a mean squared error loss; a rate distortion loss; or a compression function used in the mean squared error loss and/or the rate distortion loss.

The apparatus may further include wherein the compression function is a function used to compress the at least one compressed residual local weight update or the at least one compressed residual global weight update.

The apparatus may further include wherein the at least one institute is a plurality of institutes; wherein the at least one compressed residual local weight update is a plurality of compressed residual local weight updates; wherein the at least one local weight update is a plurality of local weight updates; wherein the at least one adjusted local weight update is a plurality of adjusted local weight updates; wherein the at least one predicted local weight update is a plurality of predicted local weight updates; wherein the at least one compressed residual global weight update is a plurality of compressed residual global weight updates; wherein the at least one memory and the computer program code are further configured to, with the at least one processor, cause the apparatus at least to: receive the plurality of compressed residual local weight updates from the plurality of respective institutes; determine the plurality of local weight updates or the plurality of adjusted local weight updates based on the plurality of compressed residual local weight updates and the plurality of respective predicted local weight updates; aggregate the plurality of determined local weight updates or the plurality of adjusted local weight updates to generate an intended global weight update, and update a model on a server based at least on the intended global weight update, the model used to perform at least one task; and transfer the plurality of compressed residual global weight update to the plurality of institutes.

An example method includes receiving at least one compressed residual local weight update from at least one institute; determining at least one local weight update or at least one adjusted local weight update based on the at least one compressed residual local weight update and at least one predicted local weight update; aggregating the determined at least one local weight update or the at least one adjusted local weight update to generate an intended global weight update, and updating a model on a server based at least on the intended global weight update, the model used to perform at least one task; and transferring at least one compressed residual global weight update to the at least one institute.

An example non-transitory program storage device readable by a machine, tangibly embodying a program of instructions executable by the machine for performing operations is provided, the operations comprising: receiving at least one compressed residual local weight update from at least one institute; determining at least one local weight update or at least one adjusted local weight update based on the at least one compressed residual local weight update and at least one predicted local weight update; aggregating the determined at least one local weight update or the at least one adjusted local weight update to generate an intended global weight update, and updating a model on a server based at least on the intended global weight update, the model used to perform at least one task; and transferring at least one compressed residual global weight update to the at least one institute.

An example method includes receiving a plurality of compressed residual local weight updates from a plurality of respective institutes with a plurality of a respective at least one first parameter, the at least one first parameter used to determine a plurality of respective predicted local weight updates; determining a plurality of local weight updates or a plurality of adjusted local weight updates based on the plurality of compressed residual local weight updates and the plurality of respective predicted local weight updates; aggregating the plurality of determined local weight updates or the plurality of adjusted local weight updates to generate an intended global weight update, and updating a model on a server based at least on the intended global weight update, the model used to perform at least one task; and transferring at least one compressed residual global weight update to the plurality of institutes with at least one second parameter, the at least one second parameter used to determine at least one predicted global weight update.

An example non-transitory program storage device readable by a machine, tangibly embodying a program of instructions executable by the machine for performing operations, the operations comprising: receiving a plurality of compressed residual local weight updates from a plurality of respective institutes with a plurality of a respective at least one first parameter, the at least one first parameter used to determine a plurality of respective predicted local weight updates; determining a plurality of local weight updates or a plurality of adjusted local weight updates based on the plurality of compressed residual local weight updates and the plurality of respective predicted local weight updates; aggregating the plurality of determined local weight updates or the plurality of adjusted local weight updates to generate an intended global weight update, and updating a model on a server based at least on the intended global weight update, the model used to perform at least one task; and transferring at least one compressed residual global weight update to the plurality of institutes with at least one second parameter, the at least one second parameter used to determine at least one predicted global weight update.

An example method includes generating a compressed residual local weight update after compressing a difference between an intended local weight update and a predicted local weight update; transferring the compressed residual local weight update from an institute to a server or other institute with at least one first parameter, the at least one first parameter used to determine the predicted local weight update; receiving a compressed residual global weight update from the server or the other institute with at least one second parameter, the at least one second parameter used to determine a predicted global weight update; and updating a local model on the institute based in part on the compressed residual global weight update, the local model used to perform at least one task.

An example non-transitory program storage device readable by a machine, tangibly embodying a program of instructions executable by the machine for performing operations is provided, the operations comprising: generating a compressed residual local weight update after compressing a difference between an intended local weight update and a predicted local weight update; transferring the compressed residual local weight update from an institute to a server or other institute with at least one first parameter, the at least one first parameter used to determine the predicted local weight update; receiving a compressed residual global weight update from the server or the other institute with at least one second parameter, the at least one second parameter used to determine a predicted global weight update; and updating a local model on the institute based in part on the compressed residual global weight update, the local model used to perform at least one task.

An example method includes receiving at least one compressed residual local weight update from at least one institute with at least one first parameter, the at least one first parameter used to determine at least one predicted local weight update; determining at least one local weight update or at least one adjusted local weight update based on the at least one compressed residual local weight update and the at least one predicted local weight update; aggregating the determined at least one local weight update or the at least one adjusted local weight update to generate an intended global weight update, and updating a model on a server based at least on the intended global weight update, the model used to perform at least one task; and transferring at least one compressed residual global weight update to the at least one institute with at least one second parameter, the at least one second parameter used to determine at least one predicted global weight update.

An example non-transitory program storage device readable by a machine, tangibly embodying a program of instructions executable by the machine for performing operations is provided, the operations comprising: receiving at least one compressed residual local weight update from at least one institute with at least one first parameter, the at least one first parameter used to determine at least one predicted local weight update; determining at least one local weight update or at least one adjusted local weight update based on the at least one compressed residual local weight update and the at least one predicted local weight update; aggregating the determined at least one local weight update or the at least one adjusted local weight update to generate an intended global weight update, and updating a model on a server based at least on the intended global weight update, the model used to perform at least one task; and transferring at least one compressed residual global weight update to the at least one institute with at least one second parameter, the at least one second parameter used to determine at least one predicted global weight update.

An apparatus includes means for receiving a plurality of compressed residual local weight updates from a plurality of respective institutes with a plurality of a respective at least one first parameter, the at least one first parameter used to determine a plurality of respective predicted local weight updates; means for determining a plurality of local weight updates or a plurality of adjusted local weight updates based on the plurality of compressed residual local weight updates and the plurality of respective predicted local weight updates; means for aggregating the plurality of determined local weight updates or the plurality of adjusted local weight updates to generate an intended global weight update, and means for updating a model on a server based at least on the intended global weight update, the model used to perform at least one task; and means for transferring at least one compressed residual global weight update to the plurality of institutes with at least one second parameter, the at least one second parameter used to determine at least one predicted global weight update.

The apparatus may further include means for generating the at least one compressed residual global weight update after compressing a difference between the intended global weight update and the at least one predicted global weight update; means for generating a global weight update based on the at least one predicted global weight update and the at least one compressed residual global weight update; wherein the model on the server is updated using the global weight update.

The apparatus may further include wherein the plurality of compressed residual local weight updates are a difference between a plurality of local weight updates of the plurality of institutes and a plurality of respective predicted local weight updates of the plurality of institutes.

The apparatus may further include means for distributing an initial model to the plurality of institutes.

The apparatus may further include wherein the model on the server is structurally similar to a local model on the respective plurality of institutes.

The apparatus may further include wherein the at least one predicted global weight update is a function of at least one global weight update of a previous iteration and the at least one second parameter transferred with the at least one compressed residual global weight update; and wherein the plurality of respective predicted local weight updates are a function of at least one local weight update of a previous iteration, the at least one global weight update of a previous iteration, and the plurality of the respective at least one first parameter received with the plurality of compressed residual local weight updates.

The apparatus may further include wherein the function for the at least one predicted global weight update or the function for the plurality of respective predicted local weight updates is defined using: respective linear autoregressive models with at least one first coefficient; or respective nonlinear functions with the at least one second coefficient.

The apparatus may further include wherein the at least one first coefficient or the at least one second coefficient is determined based on at least of: means for optimizing a mean squared error loss of the at least one predicted global weight update and an intended global weight update, and a mean squared error loss of the plurality of respective predicted local weight updates and an intended plurality of respective predicted local weight updates; means for optimizing a rate distortion loss function defined as a code length to encode the plurality of compressed residual local weight updates and the at least one compressed residual global weight update after a quantization operation using an entropy encoding method; means for using a function used to compress the plurality of compressed residual local weight updates within a term of the mean squared error loss and/or a term of the rate distortion loss function; means for compressing the at least one of the at least one first coefficient or the at least one second coefficient; or means for using an inner loop to determine the at least one first coefficient for the plurality of respective predicted local weight updates or the at least one second coefficient for the plurality of respective predicted local weight updates, and means for using an outer loop to determine the plurality of local weight updates based on prediction performance using the at least one first coefficient or the at least one second coefficient.

The apparatus may further include wherein the at least one first parameter or the at least one second parameter: provides an indication that zero should be used as a value for the plurality of respective predicted local weight updates or the at least one predicted global weight update; or provides an indication that the at least one first coefficient or the at least one second coefficient is based on a previous iteration; or provides an indication that the respective linear autoregressive models with at least one first coefficient are used for the plurality of respective predicted local weight updates and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the plurality of compressed residual local weight updates and the at least one compressed residual global weight update have been compressed using sparsification or quantization.

The apparatus may further include means for partitioning a neural network into multiple parts, wherein the neural network is used to determine at least one of: the plurality of respective predicted local weight updates, the plurality of local weight updates, the plurality of adjusted local weight updates, the update to the model on the server, the at least one compressed residual global weight update, the at least one predicted global weight update, or the at least one second parameter.

The apparatus may further include means for sending information relating to the partition of the neural network to the plurality of institutes.

The apparatus may further include wherein the plurality of local weight updates are obtained using an additional term in a loss function that encourages the plurality of local weight updates to be more predictable.

The apparatus may further include wherein the model on the server is structurally different from at least one local model on the respective plurality of institutes.

The apparatus may further include means for generating the at least one compressed residual global weight update, the at least one compressed residual global weight update being for one of the plurality of institutes, after compressing a difference between an intended global weight update for the one of the plurality of institutes and a predicted global weight update for the one of the plurality of institutes; means for generating a global weight update for the one of the plurality of institutes based on the predicted global weight update for the one of the plurality of institutes and the at least one compressed residual global weight update for the one of the plurality of institutes; and means for updating a model for the one of the plurality of institutes based on the global weight update for the one of the plurality of institutes.

The apparatus may further include means for updating the model on the server using a model on the server from a previous iteration and the intended global weight update; and means for determining the intended global weight update for the one of the plurality of institutes using the updated model on the server and a respective local model of the plurality of institutes from a previous iteration.

The apparatus may further include means for determining a model update for the plurality of institutes using a respective model from a previous iteration and a respective local weight update of the determined plurality of local weight updates; and means for determining the plurality of adjusted local weight updates using a model for a respective institute of the plurality of institutes of a current iteration and the respective model update.

The apparatus may further include wherein the at least one predicted global weight update is a function of at least one actual local weight update of the plurality of local weight updates, at least one global weight update of a previous iteration, and the at least one second parameter transferred with the at least one compressed residual global weight update; and wherein the plurality of respective predicted local weight updates are a function of at least one local weight update of a previous iteration, the at least one global weight update of a previous iteration, and the plurality of the respective at least one first parameter received with the plurality of compressed residual local weight updates.

The apparatus may further include wherein the function for the at least one predicted global weight update or the function for the plurality of respective predicted local weight updates is defined using: respective linear autoregressive models with at least one first coefficient; or respective nonlinear functions with the at least one second coefficient.

The apparatus may further include wherein the at least one first coefficient or the at least one second coefficient is determined based on at least one of: means for optimizing a mean squared error loss of the at least one predicted global weight update and an intended global weight update, and a mean squared error loss of the plurality of respective predicted local weight updates and an intended plurality of respective predicted local weight updates; means for optimizing a rate distortion loss function defined as a code length to encode the plurality of compressed residual local weight updates and the at least one compressed residual global weight update after a quantization operation using an entropy encoding method; means for using a function used to compress the plurality of compressed residual local weight updates within a term of the mean squared error loss and/or a term of the rate distortion loss function; means for compressing the at least one of the at least one first coefficient or the at least one second coefficient; or means for using an inner loop to determine the at least one first coefficient for the plurality of respective predicted local weight updates or the at least one second coefficient for the plurality of respective predicted local weight updates, and means for using an outer loop to determine the plurality of local weight updates based on prediction performance using the at least one first coefficient or the at least one second coefficient.

The apparatus may further include wherein the at least one first parameter or the at least one second parameter: provides an indication that zero should be used as a value for the plurality of respective predicted local weight updates or the at least one predicted global weight update; or provides an indication that the at least one first coefficient or the at least one second coefficient is based on a previous iteration; or provides an indication that the respective linear autoregressive models with at least one first coefficient are used for the plurality of respective predicted local weight updates and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include means for generating the at least one compressed residual global weight update based on the intended global weight update and the at least one predicted global weight update; wherein the at least one compressed residual global weight update is determined with a modulo operation that returns a remainder of a term divided with a quantization level; wherein the term is the at least one predicted global weight update subtracted from the intended global weight update added to the quantization level; wherein the at least one predicted global weight update is a first discrete value determined with the quantization level, and the intended global weight update is a second discrete value determined with the quantization level.

The apparatus may further include wherein the plurality of local weight updates are determined with a modulo operation that returns a remainder of a term divided with a quantization level; wherein the term is the plurality of predicted local weight updates added to the plurality of respective compressed residual local weight updates.

The apparatus may further include means for generating a global weight update based on the at least one predicted global weight update and the at least one compressed residual global weight update; wherein the global weight update is determined with a modulo operation that returns the remainder of term divided with a quantization level; wherein the term is the at least one predicted global weight update added to the at least one compressed residual global weight update; and wherein the model on the server is updated using the global weight update, and the model is discrete or a quantization to the global weight update.

The apparatus may further include means for partitioning the at least one predicted global weight update into two or more parts; means for partitioning the at least one second parameter into two or more parts respectively corresponding to the two or more parts of the at least one predicted global weight update; and means for generating a first part of a global weight update based on a first part of the predicted global weight update.

The apparatus may further include means for determining a second part of the at least one predicted global weight update using the first part of the global weight update, and a first part of the at least one second parameter.

The apparatus may further include means for determining the second part of the at least one predicted global weight update using at least one other variable used to determine the at least one predicted global weight update.

The apparatus may further include means for generating a second part of the global weight update based on a second part of the at least one predicted global weight update; and means for determining a third part of the at least one predicted global weight update using the first part of the global weight update, the first part of the at least one second parameter, the second part of the global weight update, and a second part of the at least one second parameter.

The apparatus may further include means for determining the third part of the at least one predicted global weight update using at least one other variable used to determine the at least one predicted global weight update.

The apparatus may further include means for partitioning one of the plurality of predicted local weight updates into two or more parts; means for partitioning the at least one first parameter into two or more parts respectively corresponding to the two or more parts of the one of the plurality of predicted local weight updates; and means for generating a first part of the one of the plurality of local weight updates based on a first part of the one of the plurality of predicted local weight updates.

The apparatus may further include means for determining a second part of the one of the plurality of predicted local weight updates using the first part of the one of the plurality of local weight updates, and a first part of the at least one first parameter.

The apparatus may further include means for determining the second part of the one of the plurality of predicted local weight updates using at least one other variable used to determine the one of the plurality of predicted local weight updates.

The apparatus may further include means for generating a second part of the one of the plurality of local weight updates based on a second part of the one of the plurality of predicted local weight updates; and means for determining a third part of the one of the plurality of predicted local weight updates using the one of the plurality of local weight updates, the first part of the at least one first parameter, the second part of the one of the plurality of local weight updates, and a second part of the at least one first parameter.

The apparatus may further include means for determining the third part of the at least one predicted global weight update using at least one other variable used to determine the at least one predicted global weight update.

The apparatus may further include means for partitioning the at least one compressed residual global weight update into two or more parts; means for partitioning the at least one second parameter into two or more parts respectively corresponding to the two or more parts of the at least one compressed residual global weight update; means for determining an order for sending the two or more parts of the at least one compressed residual global weight update and the two or more parts of the at least one second parameter; and means for transferring, based on the determined order: the order, and/or the two or more parts of the at least one compressed residual global weight update and the two or more parts of the at least one second parameter to the plurality of institutes.

The apparatus may further include means for receiving a random seed from the plurality of institutes; and means for determining the plurality of respective predicted local weight updates or the at least one predicted global weight update using the random seed when a random process is involved.

An apparatus includes means for generating a compressed residual local weight update after compressing a difference between an intended local weight update and a predicted local weight update; means for transferring the compressed residual local weight update from an institute to a server or other institute with at least one first parameter, the at least one first parameter used to determine the predicted local weight update; means for receiving a compressed residual global weight update from the server or the other institute with at least one second parameter, the at least one second parameter used to determine a predicted global weight update; and means for updating a local model on the institute based in part on the compressed residual global weight update, the local model used to perform at least one task.

The apparatus may further include means for training the local model using local data to generate the intended local weight update to the local model on the institute; and means for training the local model following the update to the local model based in part on the compressed residual global weight update to generate an adjusted local weight update used to update the local model on the institute during a subsequent iteration.

The apparatus may further include wherein the compressed residual global weight update is a compressed difference between an aggregated intended global weight update and a predicted global weight update.

The apparatus may further include means for receiving an initial model from the server or the other institute as the local model.

The apparatus may further include wherein the local model is structurally similar to a model updated on the server or the other institute that generates a global weight update.

The apparatus may further include means for determining an actual global weight update based on the predicted global weight update and the compressed residual global weight update; and means for updating the local model using the determined actual global weight update.

The apparatus may further include wherein the predicted global weight update is a function of at least one global weight update of a previous iteration and the at least one second parameter received with the residual global weight update; and wherein the predicted local weight update is a function of at least one local weight update of a previous iteration, the at least one global weight update of a previous iteration, and the at least one first parameter transferred with the compressed residual local weight update.

The apparatus may further include wherein the function for the predicted global weight update or the function for the predicted local weight update is defined using: respective linear autoregressive models with at least one first coefficient; or respective nonlinear functions with the at least one second coefficient.

The apparatus may further include wherein the at least one first coefficient or the at least one second coefficient is determined based on at least one of: means for optimizing a mean squared error loss of the predicted global weight update and an intended global weight update, and a mean squared error loss of the predicted local weight update and the intended local weight update; means for optimizing a rate distortion loss function defined as a code length to encode the compressed residual local weight update and the compressed residual global weight update after a quantization operation using an entropy encoding method; means for using a function used to compress the compressed residual local weight update within a term of the mean squared error loss and/or a term of the rate distortion loss function; means for compressing the at least one of the at least one first coefficient or the at least one second coefficient; or means for using an inner loop to determine the at least one first coefficient for the predicted local weight update or the at least one second coefficient for the predicted local weight update, and means for using an outer loop to determine the intended local weight update based on prediction performance using the at least one first coefficient or the at least one second coefficient.

The apparatus may further include wherein the at least one first parameter or the at least one second parameter: provides an indication that zero should be used as a value for the predicted local weight update or the predicted global weight update; or provides an indication that the at least one first coefficient or the at least one second coefficient is based on a previous iteration; or provides an indication that the respective linear autoregressive models with at least one first coefficient are used for the predicted local weight update and the predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the compressed residual local weight update and the compressed residual global weight update have been compressed using sparsification or quantization.

The apparatus may further include means for partitioning a neural network into multiple parts, wherein the neural network is used to determine at least one of: the compressed residual local weight update, the intended local weight update, the predicted local weight update, the predicted global weight update, the update to the local model on the institute, or the at least one first parameter.

The apparatus may further include means for sending information relating to the partition of the neural network to the server or the other institute.

The apparatus may further include wherein the intended local weight update is obtained using an additional term in a loss function that encourages the intended local weight update to be more predictable.

The apparatus may further include wherein the local model is structurally different from a model updated on the server or the other institute that generates a global weight update.

The apparatus may further include means for training the local model on the institute using local data to generate the intended local weight update to the local model on the institute; and means for training the local model following the update to the local model based in part on the compressed residual global weight update to generate an intended local weight update used to update the local model on the institute during a subsequent iteration.

The apparatus may further include wherein the predicted global weight update is a function of at least one actual local weight update, at least one global weight update of a previous iteration, and the at least one second parameter received with the residual global weight update; and wherein the predicted local weight update is a function of the at least one local weight update of a previous iteration, the at least one global weight update of a previous iteration, and the at least one first parameter transferred with the compressed residual local weight update.

The apparatus may further include wherein the function for the predicted global weight update or the function for the predicted local weight update is defined using: respective linear autoregressive models with at least one first coefficient; or respective nonlinear functions with the at least one second coefficient.

The apparatus may further include wherein the at least one first coefficient or the at least one second coefficient are determined based on at least one of: means for optimizing a mean squared error loss of the predicted global weight update and an intended global weight update, and a mean squared error loss of the predicted local weight update and the intended local weight update; means for optimizing a rate distortion loss function defined as a code length to encode the compressed residual local weight update and the compressed residual global weight update after a quantization operation using an entropy encoding method; means for using a function used to compress the compressed residual local weight update within a term of the mean squared error loss and/or a term of the rate distortion loss function; means for compressing the at least one of the at least one first coefficient or the at least one second coefficient; or means for using an inner loop to determine the at least one first coefficient for the predicted local weight update or the at least one second coefficient for the predicted local weight update, and means for using an outer loop to determine the intended local weight update based on prediction performance using the at least one first coefficient or the at least one second coefficient.

The apparatus may further include wherein the at least one first parameter or the at least one second parameter: provides an indication that zero should be used as a value for the predicted local weight update or the predicted global weight update; or provides an indication that the at least one first coefficient or the at least one second coefficient is based on a previous iteration; or provides an indication that the respective linear autoregressive models with at least one first coefficient are used for the predicted local weight update and the predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the institute is asynchronized with the server or the other institute.

The apparatus may further include wherein the compressed residual local weight update is determined with a modulo operation that returns a remainder of a term divided with a quantization level; wherein the term is the predicted local weight update subtracted from the intended local weight update added to the quantization level; wherein the predicted local weight update is a first discrete value determined with the quantization level, and the intended local weight update is a second discrete value determined with the quantization level.

The apparatus may further include means for determining an actual global weight update based on the predicted global weight update and the compressed residual global weight update; wherein the actual global weight update is determined with a modulo operation that returns a remainder of a term divided with a quantization level; wherein the term is the predicted global weight update added to the compressed residual global weight update; and means for updating the local model using the determined actual global weight update, and the local model is discrete or a quantization to the actual global weight update.

The apparatus may further include means for partitioning the predicted global weight update into two or more parts; means for partitioning the at least one second parameter into two or more parts respectively corresponding to the two or more parts of the predicted global weight update; and means for generating a first part of a global weight update based on a first part of the predicted global weight update.

The apparatus may further include means for determining a second part of the predicted global weight update using the first part of the global weight update, and a first part of the at least one second parameter.

The apparatus may further include means for determining the second part of the predicted global weight update using at least one other variable used to determine the predicted global weight update.

The apparatus may further include means for generating a second part of the global weight update based on a second part of the predicted global weight update; and means for determining a third part of the predicted global weight update using the first part of the global weight update, the first part of the at least one second parameter, the second part of the global weight update, and a second part of the at least one second parameter.

The apparatus may further include means for determining the third part of the predicted global weight update using at least one other variable used to determine the predicted global weight update.

The apparatus may further include means for partitioning the predicted local weight update into two or more parts; means for partitioning the at least one first parameter into two or more parts respectively corresponding to the two or more parts of the predicted local weight update; and means for generating a first part of the intended local weight update based on a first part of the predicted local weight update.

The apparatus may further include means for determining a second part of the predicted local weight update using the first part of the intended local weight update, and a first part of the at least one first parameter.

The apparatus may further include means for determining the second part of the predicted local weight update using at least one other variable used to determine the predicted local weight update.

The apparatus may further include means for generating a second part of the intended local weight update based on a second part of the predicted local weight update; and means for determining a third part of the predicted local weight update using the first part of the intended local weight update, the first part of the at least one first parameter, the second part of the intended local weight update, and a second part of the at least one first parameter.

The apparatus may further include means for determining the third part of the predicted local weight update using at least one other variable used to determine the predicted local weight update.

The apparatus may further include means for partitioning the compressed residual local weight update into two or more parts; means for partitioning the at least one first parameter into two or more parts respectively corresponding to the two or more parts of the compressed residual local weight update; means for determining an order for sending the two or more parts of the compressed residual local weight update and the two or more parts of the at least one first parameter; and means for transferring, based on the determined order: the order, and/or the two or more parts of the compressed residual local weight update and the two or more parts of the at least one first parameter to the server or the other institute.

The apparatus may further include means for receiving a random seed from the server or other institute; and means for determining the predicted global weight update or the predicted local weight update using the random seed when a random process is involved.

An apparatus includes means for receiving at least one compressed residual local weight update from at least one institute with at least one first parameter, the at least one first parameter used to determine at least one predicted local weight update; means for determining at least one local weight update or at least one adjusted local weight update based on the at least one compressed residual local weight update and the at least one predicted local weight update; means for aggregating the determined at least one local weight update or the at least one adjusted local weight update to generate an intended global weight update, and update a model on a server based at least on the intended global weight update, the model used to perform at least one task; and means for transferring at least one compressed residual global weight update to the at least one institute with at least one second parameter, the at least one second parameter used to determine at least one predicted global weight update.

The apparatus may further include means for generating the at least one compressed residual global weight update after compressing a difference between the intended global weight update and the at least one predicted global weight update; means for generating a global weight update based on the at least one predicted global weight update and the at least one compressed residual global weight update; wherein the model on the server is updated using the global weight update.

The apparatus may further include wherein the at least one compressed residual local weight update is a difference between at least one local weight update of the at least one institute and at least one predicted local weight update of the at least one institute.

The apparatus may further include means for distributing an initial model to the at least one institute.

The apparatus may further include wherein the model on the server is structurally similar to a local model on the at least one institute.

The apparatus may further include wherein the at least one predicted global weight update is a function of at least one global weight update of a previous iteration and the at least one second parameter transferred with the at least one compressed residual global weight update; and wherein the at least one predicted local weight update is a function of at least one local weight update of a previous iteration, the at least one global weight update of a previous iteration, and the at least one first parameter received with the at least one compressed residual local weight update.

The apparatus may further include wherein the function for the at least one predicted global weight update or the function for the at least one predicted local weight update is defined using: respective linear autoregressive models with at least one first coefficient; or respective nonlinear functions with the at least one second coefficient.

The apparatus may further include wherein the at least one first coefficient or the at least one second coefficient is determined based on at least one of: means for optimizing a mean squared error loss of the at least one predicted global weight update and an intended global weight update, and a mean squared error loss of the at least one predicted local weight update and an intended at least one predicted local weight update; means for optimizing a rate distortion loss function defined as a code length to encode the at least one compressed residual local weight update and the at least one compressed residual global weight update after a quantization operation using an entropy encoding method; means for using a function used to compress the at least one compressed residual local weight update within a term of the mean squared error loss and/or a term of the rate distortion loss function; means for compressing the at least one of the at least one first coefficient or the at least one second coefficient; or means for using an inner loop to determine the at least one first coefficient for the at least one predicted local weight update or the at least one second coefficient for the at least one predicted local weight update, and means for using an outer loop to determine the at least one local weight update based on prediction performance using the at least one first coefficient or the at least one second coefficient.

The apparatus may further include wherein the at least one first parameter or the at least one second parameter: provides an indication that zero should be used as a value for the at least one predicted local weight update or the at least one predicted global weight update; or provides an indication that the at least one first coefficient or the at least one second coefficient is based on a previous iteration; or provides an indication that the respective linear autoregressive models with at least one first coefficient are used for the at least one predicted local weight update and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include wherein the at least one compressed residual local weight update and the at least one compressed residual global weight update have been compressed using sparsification or quantization.

The apparatus may further include means for partitioning a neural network into multiple parts, wherein the neural network is used to determine at least one of: the at least one predicted local weight update, the at least one local weight update, the at least one adjusted local weight update, the update to the model on the server, the at least one compressed residual global weight update, the at least one predicted global weight update, or the at least one second parameter.

The apparatus may further include means for sending information relating to the partition of the neural network to the at least one institute.

The apparatus may further include wherein the at least one local weight update is obtained using an additional term in a loss function that encourages the at least one local weight update to be more predictable.

The apparatus may further include wherein the model on the server is structurally different from at least one local model on the at least one institute.

The apparatus may further include means for generating the at least one compressed residual global weight update, the at least one compressed residual global weight update being for one of the at least one institute, after compressing a difference between an intended global weight update for the one of the at least one institute and a predicted global weight update for the one of the at least one institute; means for generating a global weight update for the one of the at least one institute based on the predicted global weight update for the one of the at least one institute and the at least one compressed residual global weight update for the one of the at least one institute; and means for updating a model for the one of the at least one institute based on the global weight update for the one of the at least one institute.

The apparatus may further include means for updating the model on the server using a model on the server from a previous iteration and the intended global weight update; and means for determining the intended global weight update for the one of the at least one institute using the updated model on the server and a respective local model of the at least one institute from a previous iteration.

The apparatus may further include means for determining a model update for the at least one institute using a respective model from a previous iteration and a respective local weight update of the determined at least one local weight update; and means for determine the at least one adjusted local weight update using a model for a respective institute of the at least one institute of a current iteration and the respective model update.

The apparatus may further include wherein the at least one predicted global weight update is a function of at least one actual local weight update of the at least one local weight update, at least one global weight update of a previous iteration, and the at least one second parameter transferred with the at least one compressed residual global weight update; and wherein the at least one predicted local weight update is a function of at least one local weight update of a previous iteration, the at least one global weight update of a previous iteration, and the at least one first parameter received with the at least one compressed residual local weight update.

The apparatus may further include wherein the function for the at least one predicted global weight update or the function for the at least one predicted local weight update is defined using: respective linear autoregressive models with at least one first coefficient; or respective nonlinear functions with the at least one second coefficient.

The apparatus may further include wherein the at least one first coefficient or the at least one second coefficient is determined based on at least one of: means for optimizing a mean squared error loss of the at least one predicted global weight update and an intended global weight update, and a mean squared error loss of the at least one predicted local weight update and an intended at least one predicted local weight update; means for optimizing a rate distortion loss function defined as a code length to encode the at least one compressed residual local weight update and the at least one compressed residual global weight update after a quantization operation using an entropy encoding method; means for using a function used to compress the at least one compressed residual local weight update within a term of the mean squared error loss and/or a term of the rate distortion loss function; means for compressing the at least one of the at least one first coefficient or the at least one second coefficient; or means for using an inner loop to determine the at least one first coefficient for the at least one predicted local weight update or the at least one second coefficient for the at least one predicted local weight update, and means for using an outer loop to determine the at least one local weight update based on prediction performance using the at least one first coefficient or the at least one second coefficient.

The apparatus may further include wherein the at least one first parameter or the at least one second parameter: provides an indication that zero should be used as a value for the at least one respective predicted local weight update or the at least one predicted global weight update; or provides an indication that the at least one first coefficient or the at least one second coefficient is based on a previous iteration; or provides an indication that the respective linear autoregressive models with at least one first coefficient are used for the at least one predicted local weight updates and the at least one predicted global weight update; or provides an indication that the at least one first coefficient or the at least one second coefficient is determined via minimizing a loss function up to a previous iteration, and comprises an integer number that indicates a distance from an iteration the at least one first coefficient or the at least one second coefficient is derived to the current iteration; or comprises the at least one first coefficient or the at least one second coefficient, or a residual of the at least one first coefficient or the at least one second coefficient; or provides an indication that the at least one first coefficient or the at least one second coefficient is determined using a residual of the at least one first coefficient or the at least one second coefficient.

The apparatus may further include means for generating the at least one compressed residual global weight update based on the intended global weight update and the at least one predicted global weight update; wherein the at least one compressed residual global weight update is determined with a modulo operation that returns a remainder of a term divided with a quantization level; wherein the term is the at least one predicted global weight update subtracted from the intended global weight update added to the quantization level; and wherein the at least one predicted global weight update is a first discrete value determined with the quantization level, and the intended global weight update is a second discrete value determined with the quantization level.

The apparatus may further include wherein the at least one local weight update is determined with a modulo operation that returns a remainder of a term divided with a quantization level; and wherein the term is the at least one predicted local weight update added to the at least one compressed residual local weight update.

The apparatus may further include means for generating a global weight update based on the at least one predicted global weight update and the at least one compressed residual global weight update; wherein the global weight update is determined with a modulo operation that returns the remainder of term divided with a quantization level; wherein the term is the at least one predicted global weight update added to the at least one compressed residual global weight update; and wherein the model on the server is updated using the global weight update, and the model is discrete or a quantization to the global weight update.

The apparatus may further include means for partitioning the at least one predicted global weight update into two or more parts; means for partitioning the at least one second parameter into two or more parts respectively corresponding to the two or more parts of the at least one predicted global weight update; and means for generating a first part of a global weight update based on a first part of the predicted global weight update.

The apparatus may further include means for determining a second part of the at least one predicted global weight update using the first part of the global weight update, and a first part of the at least one second parameter.

The apparatus may further include means for determining the second part of the at least one predicted global weight update using at least one other variable used to determine the at least one predicted global weight update.

The apparatus may further include means for generating a second part of the global weight update based on a second part of the at least one predicted global weight update; and means for determining a third part of the at least one predicted global weight update using the first part of the global weight update, the first part of the at least one second parameter, the second part of the global weight update, and a second part of the at least one second parameter.

The apparatus may further include means for determining the third part of the at least one predicted global weight update using at least one other variable used to determine the at least one predicted global weight update.

The apparatus may further include means for partitioning one of the at least one predicted local weight update into two or more parts; means for partitioning the at least one first parameter into two or more parts respectively corresponding to the two or more parts of the one of the at least one predicted local weight update; and means for generating a first part of the one of the at least one local weight update based on a first part of the one of the at least one predicted local weight update.

The apparatus may further include means for determining a second part of the one of the at least one predicted local weight update using the first part of the one of the at least one local weight update, and a first part of the at least one first parameter.

The apparatus may further include means for determining the second part of the one of the at least one predicted local weight update using at least one other variable used to determine the one of the at least one predicted local weight update.

The apparatus may further include means for generating a second part of the one of the at least one local weight update based on a second part of the one of the at least one predicted local weight update; and means for determining a third part of the one of the at least one predicted local weight update using the one of the at least one local weight update, the first part of the at least one first parameter, the second part of the one of the at least one local weight update, and a second part of the at least one first parameter.

The apparatus may further include means for determining the third part of the at least one predicted global weight update using at least one other variable used to determine the at least one predicted global weight update.

The apparatus may further include means for partitioning the at least one compressed residual global weight update into two or more parts; means for partitioning the at least one second parameter into two or more parts respectively corresponding to the two or more parts of the at least one compressed residual global weight update; means for determining an order for sending the two or more parts of the at least one compressed residual global weight update and the two or more parts of the at least one second parameter; and means for transferring, based on the determined order: the order, and/or the two or more parts of the at least one compressed residual global weight update and the two or more parts of the at least one second parameter to the at least one institute.

The apparatus may further include means for receiving a random seed from the at least one institute; and means for determining the at least one predicted local weight update or the at least one predicted global weight update using the random seed when a random process is involved.

An apparatus includes means for receiving a plurality of compressed residual local weight updates from a plurality of respective institutes; means for determining a plurality of local weight updates or a plurality of adjusted local weight updates based on the plurality of compressed residual local weight updates and a plurality of respective predicted local weight updates; means for aggregating the plurality of determined local weight updates or the plurality of adjusted local weight updates to generate an intended global weight update, and means for updating a model on a server based at least on the intended global weight update, the model used to perform at least one task; and means for transferring at least one compressed residual global weight update to the plurality of institutes.

The apparatus may further include wherein the plurality of compressed residual local weight updates and the at least one compressed residual global weight update have been compressed using sparsification or quantization.

The apparatus may further include wherein the plurality of compressed residual local weight updates are received from the plurality of respective institutes with a plurality of a respective at least one first parameter, the at least one first parameter used to determine a plurality of respective predicted local weight updates; and wherein the at least one compressed residual global weight update is transferred to the plurality of institutes with at least one second parameter, the at least one second parameter used to determine at least one predicted global weight update.

The apparatus may further include means for partitioning the model into two or more parts, wherein actual weight updates and parameters to calculate predicted weight updates of some parts of the model are used to calculate predicted weight updates of other parts of the model.

The apparatus may further include wherein the plurality of compressed residual local weight updates and the at least one compressed residual global weight update are calculated with a cyclic modulo operator.

An apparatus includes means for generating a compressed residual local weight update after compressing a difference between an intended local weight update and a predicted local weight update; means for transferring the compressed residual local weight update from an institute to a server or other institute; means for receiving a compressed residual global weight update from the server or the other institute; and means for updating a local model on the institute based in part on the compressed residual global weight update, the local model used to perform at least one task.

The apparatus may further include wherein the compressed residual local weight update and the compressed residual global weight update have been compressed using sparsification or quantization.

The apparatus may further include wherein the compressed residual local weight update is transferred from the institute to the server or other institute with at least one first parameter, the at least one first parameter used to determine the predicted local weight update; and wherein the compressed residual global weight update is received from the server or the other institute with at least one second parameter, the at least one second parameter used to determine a predicted global weight update.

The apparatus may further include means for partitioning the local model into two or more parts, wherein actual weight updates and parameters to calculate predicted weight updates of some parts of the local model are used to calculate predicted weight updates of other parts of the local model.

The apparatus may further include wherein the compressed residual local weight update and the compressed residual global weight update are calculated with a cyclic modulo operator.

The apparatus may further include wherein the predicted local weight update is determined as a linear autoregressive function, and a predicted global weight update is determined as a linear autoregressive function.

The apparatus may further include wherein the predicted local weight update is determined as a nonlinear function with at least one first coefficient, and a predicted global weight update is determined as a nonlinear function with at least one second coefficient.

The apparatus may further include wherein the at least one first coefficient or the at least one second coefficient is determined based on at least one of: a mean squared error loss; a rate distortion loss; or a compression function used in the mean squared error loss and/or the rate distortion loss.

The apparatus may further include wherein the compression function is a function used to compress either the compressed residual local weight update or the compressed residual global weight update.

An apparatus includes means for receiving at least one compressed residual local weight update from at least one institute; means for determining at least one local weight update or at least one adjusted local weight update based on the at least one compressed residual local weight update and at least one predicted local weight update; means for aggregating the determined at least one local weight update or the at least one adjusted local weight update to generate an intended global weight update, and update a model on a server based at least on the intended global weight update, the model used to perform at least one task; and means for transferring at least one compressed residual global weight update to the at least one institute.

The apparatus may further include wherein the at least one compressed residual local weight update and the at least one compressed residual global weight update have been compressed using sparsification or quantization.

The apparatus may further include wherein the at least one compressed residual local weight update is received from the at least one institute with at least one first parameter, the at least one first parameter used to determine the at least one predicted local weight update; and wherein the at least one compressed residual global weight update is transferred to the at least one institute with at least one second parameter, the at least one second parameter used to determine at least one predicted global weight update.

The apparatus may further include means for partitioning the model into two or more parts, wherein actual weight updates and parameters to calculate predicted weight updates of some parts of the model are used to calculate predicted weight updates of other parts of the model.

The apparatus may further include wherein the at least one compressed residual local weight update and the at least one compressed residual global weight update are calculated with a cyclic modulo operator.

The apparatus may further include wherein the at least one predicted local weight update is determined as a linear autoregressive function, and at least one predicted global weight update is determined as a linear autoregressive function.

The apparatus may further include wherein the predicted local weight update is determined as a nonlinear function with at least one first coefficient, and at least one predicted global weight update is determined as a nonlinear function with at least one second coefficient.

The apparatus may further include wherein the at least one first coefficient or the at least one second coefficient is determined based on at least one of: a mean squared error loss; a rate distortion loss; or a compression function used in the mean squared error loss and/or the rate distortion loss.

The apparatus may further include wherein the compression function is a function used to compress the at least one compressed residual local weight update or the at least one compressed residual global weight update.

The apparatus may further include wherein the at least one institute is a plurality of institutes; wherein the at least one compressed residual local weight update is a plurality of compressed residual local weight updates; wherein the at least one local weight update is a plurality of local weight updates; wherein the at least one adjusted local weight update is a plurality of adjusted local weight updates; wherein the at least one predicted local weight update is a plurality of predicted local weight updates; wherein the at least one compressed residual global weight update is a plurality of compressed residual global weight updates; means for receiving the plurality of compressed residual local weight updates from the plurality of respective institutes; means for determining the plurality of local weight updates or the plurality of adjusted local weight updates based on the plurality of compressed residual local weight updates and the plurality of respective predicted local weight updates; means for aggregating the plurality of determined local weight updates or the plurality of adjusted local weight updates to generate an intended global weight update, and means for updating a model on a server based at least on the intended global weight update, the model used to perform at least one task; and means for transferring the plurality of compressed residual global weight update to the plurality of institutes.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows:
3GPP 3rd generation partnership project
4G fourth generation of broadband cellular network technology
5G fifth generation cellular network technology
802.x family of IEEE standards dealing with local area networks and metropolitan area networks
ASIC application specific integrated circuit
CDMA code-division multiple access
CPC computer program code
DCT discrete cosine transform
DSP digital signal processor
ECSEL Electronic Components and Systems for European Leadership
FedAvg federated averaging
FDMA frequency division multiple access
FPGA field programmable gate array
GSM global system for mobile communications
H.222.0 MPEG-2 systems, standard for the generic coding of moving pictures and associated audio information
H.26x family of video coding standards in the domain of the ITU-T
HMD head mounted display
IBC intra block copy
IEC International Electrotechnical Commission
IEEE Institute of Electrical and Electronics Engineers
I/F interface
IMD integrated messaging device
IMS instant messaging service
IoT internet of things
IP internet protocol
ISO International Organization for Standardization
ISOBMFF ISO base media file format
ITU International Telecommunication Union
ITU-T ITU Telecommunication Standardization Sector
JU joint undertaking
LTE long-term evolution
ML machine learning
MMS multimedia messaging service
MPEG moving picture experts group
MPEG-2 H.222/H.262 as defined by the ITU
MSE mean squared error
NAL network abstraction layer
NN neural network
N/W network
PC personal computer
PDA personal digital assistant
PID packet identifier
PLC power line communication
RFID radio frequency identification
RFM reference frame memory
SMS short messaging service
TCP-IP transmission control protocol-Internet protocol
TDMA time divisional multiple access
TS transport stream
TV television
UICC universal integrated circuit card
UMTS universal mobile telecommunications system
USB universal serial bus
VGG-16 visual geometry group-16 convolutional neural network model of the University of Oxford
VVC versatile video codec
WLAN wireless local area network

1. An apparatus comprising:
at least one processor; and
at least one non-transitory memory including computer program code;
wherein the at least one memory and the computer program code are configured to, with the at least one processor, cause the apparatus at least to:
receive a plurality of compressed residual local weight updates from a plurality of respective institutes with a plurality of a respective at least one first parameter, the at least one first parameter used to determine a plurality of respective predicted local weight updates;
determine a plurality of local weight updates or a plurality of adjusted local weight updates based on the plurality of compressed residual local weight updates and the plurality of respective predicted local weight updates;
aggregate the plurality of determined local weight updates or the plurality of adjusted local weight updates to generate an intended global weight update, and update a model on a server based at least on the intended global weight update, the model used to perform at least one task; and
transfer at least one compressed residual global weight update to the plurality of institutes with at least one second parameter, the at least one second parameter used to determine at least one predicted global weight update.

2. The apparatus of claim 1, wherein the at least one memory and the computer program code are further configured to, with the at least one processor, cause the apparatus at least to:
generate the at least one compressed residual global weight update after compressing a difference between the intended global weight update and the at least one predicted global weight update;
generate a global weight update based on the at least one predicted global weight update and the at least one compressed residual global weight update;
wherein the model on the server is updated using the global weight update.

3. The apparatus of claim 1, wherein the plurality of compressed residual local weight updates are a difference between a plurality of local weight updates of the plurality of institutes and a plurality of respective predicted local weight updates of the plurality of institutes.

4. The apparatus of claim 1, wherein the at least one memory and the computer program code are further configured to, with the at least one processor, cause the apparatus at least to:
distribute an initial model to the plurality of institutes.

5. The apparatus of claim 1, wherein the at least one memory and the computer program code are further configured to, with the at least one processor, cause the apparatus at least to:
generate the at least one compressed residual global weight update based on the intended global weight update and the at least one predicted global weight update;
wherein the at least one compressed residual global weight update is determined with a modulo operation that returns a remainder of a term divided with a quantization level;
wherein the term is the at least one predicted global weight update subtracted from the intended global weight update added to the quantization level;
wherein the at least one predicted global weight update is a first discrete value determined with the quantization level, and the intended global weight update is a second discrete value determined with the quantization level.

6. The apparatus of claim 1, wherein the at least one memory and the computer program code are further configured to, with the at least one processor, cause the apparatus at least to:
partition the at least one predicted global weight update into two or more parts;
partition the at least one second parameter into two or more parts respectively corresponding to the two or more parts of the at least one predicted global weight update; and
generate a first part of a global weight update based on a first part of the predicted global weight update.

7. The apparatus of claim 1, wherein the at least one memory and the computer program code are further configured to, with the at least one processor, cause the apparatus at least to:
receive a random seed from the plurality of institutes; and
determine the plurality of respective predicted local weight updates or the at least one predicted global weight update using the random seed when a random process is involved.

8. An apparatus comprising:
at least one processor; and
at least one non-transitory memory including computer program code;
wherein the at least one memory and the computer program code are configured to, with the at least one processor, cause the apparatus at least to:
generate a compressed residual local weight update after compressing a difference between an intended local weight update and a predicted local weight update;
transfer the compressed residual local weight update from an institute to a server or other institute with at least one first parameter, the at least one first parameter used to determine the predicted local weight update;
receive a compressed residual global weight update from the server or the other institute with at least one second parameter, the at least one second parameter used to determine a predicted global weight update; and
update a local model on the institute based in part on the compressed residual global weight update, the local model used to perform at least one task.

9. The apparatus of claim 8, wherein the at least one memory and the computer program code are further configured to, with the at least one processor, cause the apparatus at least to:
train the local model using local data to generate the intended local weight update to the local model on the institute; and
train the local model following the update to the local model based in part on the compressed residual global weight update to generate an adjusted local weight update used to update the local model on the institute during a subsequent iteration.

10. The apparatus of claim 8, wherein the compressed residual global weight update is a compressed difference between an aggregated intended global weight update and a predicted global weight update.

11. The apparatus of claim 8, wherein the at least one memory and the computer program code are further configured to, with the at least one processor, cause the apparatus at least to:
receive an initial model from the server or the other institute as the local model.

12. The apparatus of claim 8,
wherein the compressed residual local weight update is determined with a modulo operation that returns a remainder of a term divided with a quantization level;
wherein the term is the predicted local weight update subtracted from the intended local weight update added to the quantization level;
wherein the predicted local weight update is a first discrete value determined with the quantization level, and the intended local weight update is a second discrete value determined with the quantization level.

13. The apparatus of claim 8, wherein the at least one memory and the computer program code are further configured to, with the at least one processor, cause the apparatus at least to:
partition the predicted global weight update into two or more parts;
partition the at least one second parameter into two or more parts respectively corresponding to the two or more parts of the predicted global weight update; and
generate a first part of a global weight update based on a first part of the predicted global weight update.

14. The apparatus of claim 8, wherein the at least one memory and the computer program code are further configured to, with the at least one processor, cause the apparatus at least to:
receive a random seed from the server or other institute; and
determine the predicted global weight update or the predicted local weight update using the random seed when a random process is involved.

15. An apparatus comprising:
at least one processor; and
at least one non-transitory memory including computer program code;
wherein the at least one memory and the computer program code are configured to, with the at least one processor, cause the apparatus at least to:
receive at least one compressed residual local weight update from at least one institute with at least one first parameter, the at least one first parameter used to determine at least one predicted local weight update;
determine at least one local weight update or at least one adjusted local weight update based on the at least one compressed residual local weight update and the at least one predicted local weight update;
aggregate the determined at least one local weight update or the at least one adjusted local weight update to generate an intended global weight update, and update a model on a server based at least on the intended global weight update, the model used to perform at least one task; and
transfer at least one compressed residual global weight update to the at least one institute with at least one second parameter, the at least one second parameter used to determine at least one predicted global weight update.

16. The apparatus of claim 15, wherein the at least one memory and the computer program code are further configured to, with the at least one processor, cause the apparatus at least to:
generate the at least one compressed residual global weight update after compressing a difference between the intended global weight update and the at least one predicted global weight update;
generate a global weight update based on the at least one predicted global weight update and the at least one compressed residual global weight update;
wherein the model on the server is updated using the global weight update.

17. The apparatus of claim 15, wherein the at least one compressed residual local weight update is a difference between at least one local weight update of the at least one institute and at least one predicted local weight update of the at least one institute.

18. The apparatus of claim 15, wherein the at least one memory and the computer program code are further configured to, with the at least one processor, cause the apparatus at least to:
generate the at least one compressed residual global weight update based on the intended global weight update and the at least one predicted global weight update;
wherein the at least one compressed residual global weight update is determined with a modulo operation that returns a remainder of a term divided with a quantization level;
wherein the term is the at least one predicted global weight update subtracted from the intended global weight update added to the quantization level; and
wherein the at least one predicted global weight update is a first discrete value determined with the quantization level, and the intended global weight update is a second discrete value determined with the quantization level.

19. The apparatus of claim 15, wherein the at least one memory and the computer program code are further configured to, with the at least one processor, cause the apparatus at least to:
partition the at least one predicted global weight update into two or more parts;
partition the at least one second parameter into two or more parts respectively corresponding to the two or more parts of the at least one predicted global weight update; and
generate a first part of a global weight update based on a first part of the predicted global weight update.

20. The apparatus of claim 15, wherein the at least one memory and the computer program code are further configured to, with the at least one processor, cause the apparatus at least to:
receive a random seed from the at least one institute; and
determine the at least one predicted local weight update or the at least one predicted global weight update using the random seed when a random process is involved.
